(19) United States
(12) Patent Application Publication
(10) Pub. No.: US 2015/0036693 A1
(43) Pub. Date: Feb. 5, 2015

(54) TRANSMISSION APPARATUS FOR TRAIN VEHICLE, TRAIN VEHICLE, CONTROL METHOD, AND CONTROL PROGRAM

(71) Applicant: Hideyuki Takahashi, Fuchu Tokyo (JP)

(72) Inventor: Hideyuki Takahashi, Fuchu Tokyo (JP)

(73) Assignee: KABUSHIKI KAISHA TOSHIBA, Minato-ku, Tokyo (JP)

(21) Appl. No.: 14/379,655

(22) PCT Filed: May 30, 2012
(86) PCT No.: PCT/JP2012/063913

§ 371 Date: Aug. 19, 2014

(51) Int. Cl. H04L 12/403

(52) U.S. Cl. CPC H04L 12/403; H04L 2012/40293
USPC 370/451

(57) ABSTRACT

According to an embodiment, a transmission apparatus is installed in a locomotive having ID information. A first connecting direction and a second connecting direction opposite the first connecting direction are defined for the locomotive. The transmission apparatus includes a transmission unit and a connection state determination unit. The transmission unit transmits the ID information received from other locomotive from one of the first connecting direction and the second connecting direction to other one of the first connecting direction and the second connecting direction. The connection state determination unit determines a connection state between the other locomotive and the locomotive in which the transmission apparatus is installed, based on the received ID information.

### CROSS-REFERENCE TO RELATED APPLICATIONS

This application is a national stage application of International Application No. PCT/JP2012/063913, filed May 30, 2012, which designates the United States and is incorporated herein by reference.

### FIELD

Embodiments described herein relate generally to a transmission apparatus for a train vehicle, a train vehicle, and a control method.

### BACKGROUND

Conventionally, a locomotive system that routinely performs connection/disconnection is provided with: a relay for detecting the connection/disconnection; and a setting device for setting a formation configuration. By the setting of the setting device, number of vehicles configuring a formation, an order of connection of vehicles having identifiers and vehicle identifiers, a direction of the vehicles (inbound/outbound direction), and the like, are manually set.

Regarding the transmission apparatus for the train vehicle configured as described above, there are cases in which a network is established in the train vehicle.

As described above, even if the network is to be established in the train vehicle, the order of connection of each transmission apparatus is known. Thus, information on the each transmission apparatus or the electric product is accurately provided to a crew member or a monitor device by acquiring an absolute position of the each transmission apparatus or an electric product in the formation.

However, according to the above-mentioned conventional transmission apparatus for the train vehicle, every time configuration of the formation changes, the crew member is required to precisely set: the number of vehicles in the formation; the order of connection of the vehicles having the identifiers and the vehicle identifiers; and the direction (inbound/outbound direction) of each of the locomotives. Therefore, also because there are many items to be set, a setup error of the crew member is easily induced, and thereby causing a problem for building a network in the train vehicle suitable for simple multi connection.

Further, in the multi connection compatible locomotive system, not only that the setup error induces a display error, but it also has influence on matters related to train driving such as reversing forward/backward movement of the train vehicle and reversing left/right direction of the vehicle.

### BRIEF DESCRIPTION OF DRAWINGS

FIG. 1 is a schematic configuration view of a transmission system for train vehicles according to an embodiment;

FIG. 2 is a schematic configuration view of a transmission apparatus according to the embodiment;

FIG. 3 is a schematic configuration diagram of a transmission core unit according to the embodiment;

FIG. 4 is a view for explaining an operation at an initial state according to the embodiment;

FIG. 5 is a flowchart of a processing of an embodiment according to the embodiment;

FIG. 6 is a view for explaining a state of a transmission table and a reception table immediately after power is turned on according to the embodiment;

FIG. 7 is a view for explaining a state of the transmission table and the reception table after a locomotive ID is set according to the embodiment;

FIG. 8 is an explanatory view of a data format of a connection confirmation command according to the embodiment;

FIG. 9 is a view for explaining a state of the transmission table and the reception table after a first connection confirmation command is received according to the embodiment;

FIG. 10 is a view for explaining a state of the transmission table and the reception table after the first connection confirmation command is received and after storing in follow-up manner is performed according to the embodiment;

FIG. 11 is a view for explaining a state of the transmission table and the reception table after second connection confirmation command is received according to the embodiment;

FIG. 12 is a view for explaining a state of the transmission table and the reception table after the second connection confirmation command is received and after storing in follow-up manner is performed according to the embodiment;

FIG. 13 is a view for explaining a state of the transmission table and the reception table after a third connection confirmation command is received according to the embodiment;

FIG. 14 is a view for explaining a state of the transmission table and the reception table after the third connection confirmation command is received and storing in a follow-up manner is performed according to the embodiment;

FIG. 15 is a view for explaining a state of the transmission table and the reception table after a fourth connection confirmation command is received according to the embodiment;

FIG. 16 is a view for explaining a state of the transmission table and the reception table after the fourth connection confirmation command is received and after storing in a follow-up manner is performed according to the embodiment;

FIG. 17 is a view for explaining a state of the transmission table and the reception table after a fifth connection confirmation command is received according to the embodiment;

FIGS. 18A-18E are views for explaining a confirmation state of number of connection and vehicle formation state of each locomotive after a connection confirmation processing is performed according to the embodiment;

FIG. 19 is a processing flowchart of a direction confirmation processing according to the embodiment;

FIG. 20 is an explanatory view of a data format of a first direction confirmation command and a second direction confirmation command according to the embodiment; and

FIGS. 21A-21E are explanatory views of a direction confirmation processing according to the embodiment.

### DETAILED DESCRIPTION

According to an embodiment, a transmission apparatus is installed in a locomotive having ID information. A first connecting direction and a second connecting direction opposite the first connecting direction are defined for the locomotive. The transmission apparatus includes a transmission unit and a connection state determination unit. The transmission unit transmits the ID information received from other locomotive from one of the first connecting direction and the second connecting direction to other one of the first connecting direction and the second connecting direction. The connection state determination unit determines a connection state between the other locomotive and the locomotive in which the transmission apparatus is installed, based on the received ID information.

Next, embodiments are described with reference to the drawings.

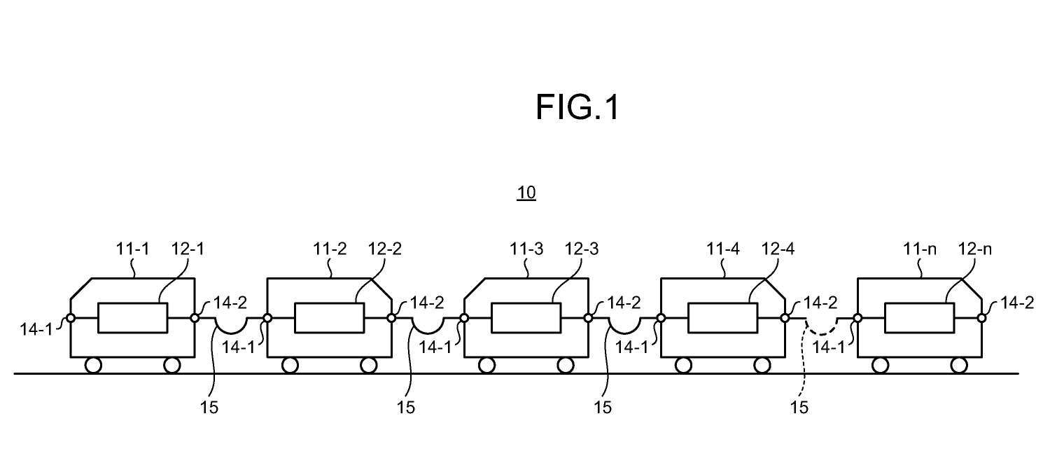

FIG. 1 is a schematic configuration view of a transmission system for a train vehicle.

A transmission system 10 for a train vehicle comprises n transmission apparatuses (transmission apparatus for a train vehicle) 12-1 to 12-n (where n is a natural number of greater than or equal to two) installed, respectively, in n locomotives 11-1 to 11-n connected to each other to form a vehicle formation.

Each of the transmission devices 12-1 to 12-n comprises a first connector 14-1 and a second connector 14-2. The first connector 14-1 and the second connector 14-2 are for performing communication (information transmission) with respect to other transmission apparatus (in FIG. 1, the transmission devices 12-1 and 12-3) installed in a locomotive (if taking the transmission apparatus 12-2 of FIG. 1 as an example, it is the locomotives 11-1 and 11-3 since the transmission apparatus 12-2 is installed in the locomotive 11-2) connected to the locomotive 11-1 to 11-n in which the transmission apparatuses 12-1 to 12-n are installed, respectively.

Here, the first connector 14-1 and the second connector 14-2 have substantially the same configuration. Therefore, for simplifying the following explanation, the first connector 14-1 is considered as a connector for performing transmission (communication) with respect to other locomotive connected in a first predetermined direction (in the explanation below, it is the leftward direction in the figure) of when the locomotives 11-1 to 11-n are multiply connected to each other. Further, the second connector 14-2 is considered as a connector for performing transmission (communication) with respect to other locomotive connected in a second predetermined direction (in the explanation below, it is the rightward direction in the figure) of when the locomotives 11-1 to 11-n are multiply connected to each other.

Each of the locomotives 11-1 to 11-n preliminarily stores therein whether the first connector 14-1 is provided at front (a predetermined locomotive front direction) or back (a predetermined locomotive back direction) of the each of the locomotives 11-1 to 11-n and whether the second connector 14-2 is provided at the front or back of the each of the locomotives 11-1 to 11-n.

Further, the first connector 14-1 and the second connector 14-2 are connected to each other via a communication cable 15.

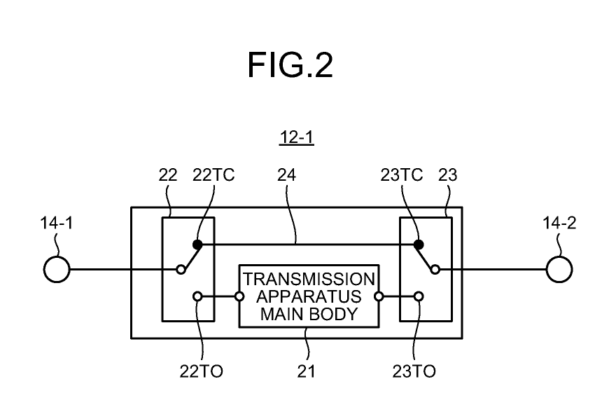

FIG. 2 is a schematic configuration view of a transmission apparatus.

The transmission apparatuses 12-1 to 12-n have the same configuration, thereby the transmission apparatus 12-1 is explained as an example.

The transmission apparatus 12-1 roughly includes: a first switch 22; a second switch 23; and a bypass transmission path 24. The first switch connects the transmission core unit 21 to the first connector 14-1 when the locomotive 11-1 supplies power to the transmission apparatus 12-1. The second switch connects the transmission core unit 21 to the second connector 14-2 when the locomotive 11-1 supplies power to the transmission apparatus 12-1. The bypass transmission path 24 connects a normally-closed contact point (NC contact point) 22TC of the first switch 22 and a normally-closed contact point (NC contact point) 22TC of the second switch 23 with each other, and forms a transmission path bypassing the transmission core unit 21 during when the power has not been supplied. The first switch 22 and the second switch 23 can for example be realized by an electromagnetic switch.

In the above configuration, the transmission core unit 21 is connected to a normally-open contact point (NO contact point) 22TO of the first switch 22 and a normally-open contact point (NO contact point) 23TO of the second switch 23, therebetween.

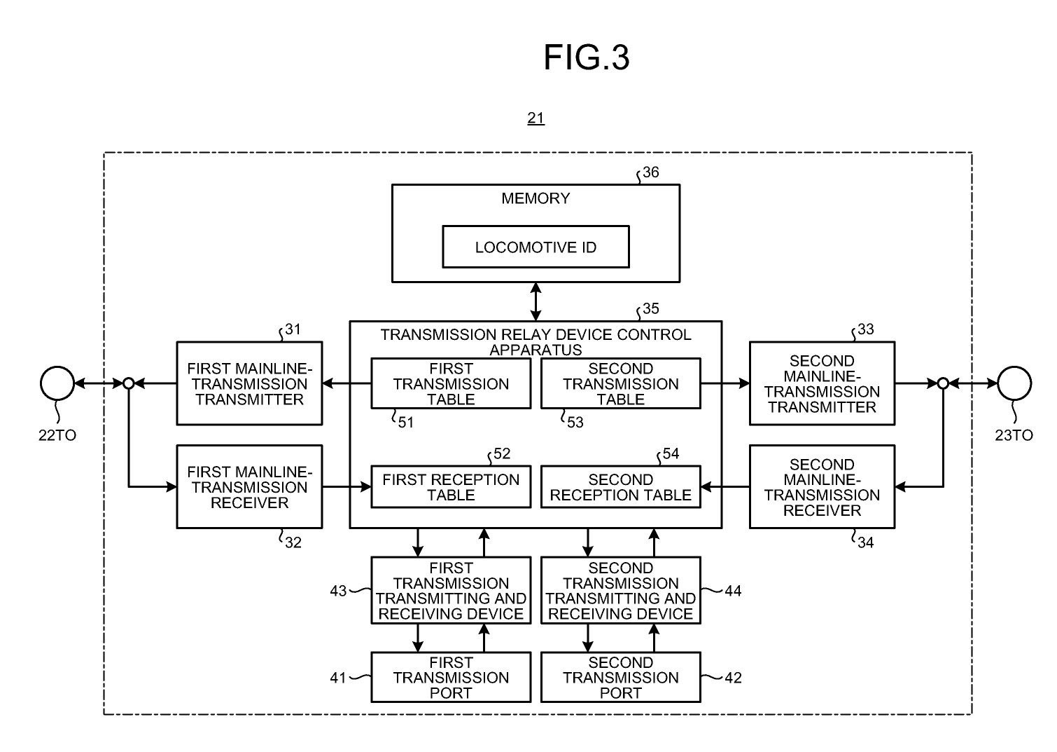

FIG. 3 is a schematic configuration view of the transmission core unit.

The transmission core unit 21 includes: a first main transmitter 31; a first main receiver 32; a second main transmitter 33; and a second main receiver 34. An output side of the first main transmitter 31 is connected to the normally-open contact point (NO contact point) 22TO of the first switch 22. An input side of the first main receiver 32 is connected to the normally-open contact point (NO contact point) 22TO of the first switch 22. An output side of the second main transmitter 33 is connected to the normally-open contact point (NO contact point) 23TO of the second switch 23. An input side of the second main receiver 34 is connected to the normally-open contact point (NO contact point) 23TO of the second switch 23.

Further, the transmission core unit 21 includes a transmission relay device control apparatus 35 and a memory 36. The transmission relay device control apparatus 35 performs transmission control by using the first main transmitter 31, the first main receiver 32, the second main transmitter 33, and the second main receiver 34. The memory 36 stores therein: locomotive IDs for identifying locomotives, respectively; and various data.

Here, locomotive numbers uniquely assigned to the locomotives, respectively, are used as the locomotive IDs. The locomotive numbers are preliminarily set by a setting switch such as a dip switch. As long as uniquely assigned, a product serial number of the vehicle, an IP address, a MAC address, or the like, may be used as the locomotive ID.

Further, the transmission core unit 21 includes: a first transmission port 41; a second transmission port 42; a first transmitter/receiver 43; and a second transmitter/receiver 44. A device installed in the locomotive in which the transmission core unit 21 is installed is connected to the first transmission port 41 and the second transmission port 42. The first transmission transmitter/receiver 43 performs transmission (communication) by performing an interface operation between the first transmission port 41 and the transmission relay device control apparatus 35. The second transmitter/receiver 44 performs transmission (communication) by performing an interface operation between the second transmission port 42 and the transmission relay device control apparatus 35.

In the above-mentioned configuration, the transmission relay device control apparatus 35 includes: a first transmission table 51; a first reception table 52; a second transmission table 53; and a second reception table 54. The first transmission table 51 temporarily stores therein transmission data to be transmitted via the first main transmitter 31. The first reception table 52 temporarily stores therein reception data received via the first main receiver 32. The second transmission table 53 temporarily stores therein transmission data to be transmitted via the second main transmitter 33. The second reception table 54 temporality stores therein reception data received via the second main receiver 34.

Next, an operation of the embodiment is explained.

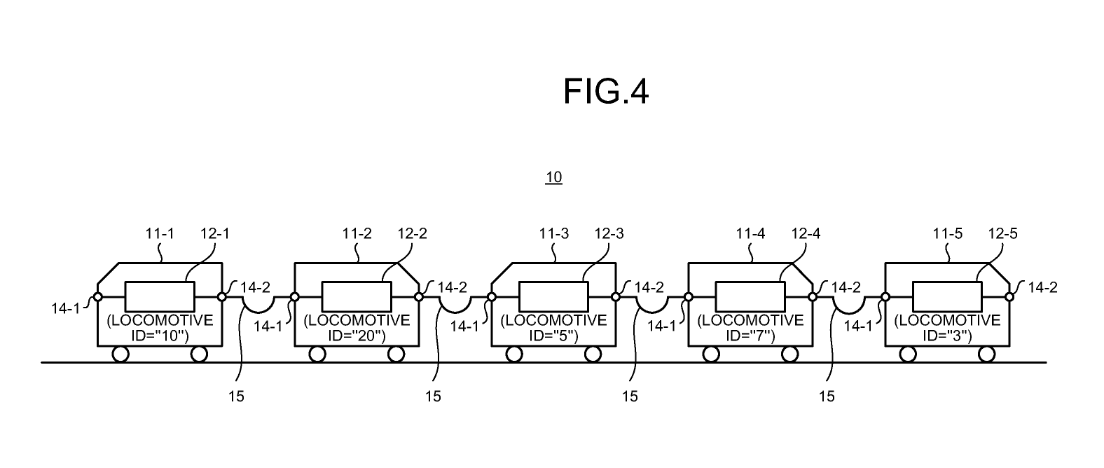

FIG. 4 is a view for explaining an operation at an initial state.

Regarding locomotives, there are provided five locomotives, i.e., locomotives 11-1 to 11-5, which are multiply connected to each other, in FIG. 4. In FIG. 4, the leftward direction is defined as a reference direction (front direction) of the locomotive 11-1, the rightward direction is defined as the reference direction of the locomotive 11-2, the leftward direction is defined as the reference direction of the locomotive 11-3, the rightward direction is defined as the reference direction of the locomotive 11-4, and the rightward direction is defined as the reference direction of the locomotive 11-5.

Further, the locomotive ID for identifying the locomotive 11-1 is defined as “10”, the locomotive ID for identifying the locomotive 11-2 is defined as “20”, the locomotive ID for identifying the locomotive 11-3 is defined as “5”, the locomotive ID for identifying the locomotive 11-4 is defined as “7”, and the locomotive ID for identifying the locomotive 11-5 is defined as “3”.

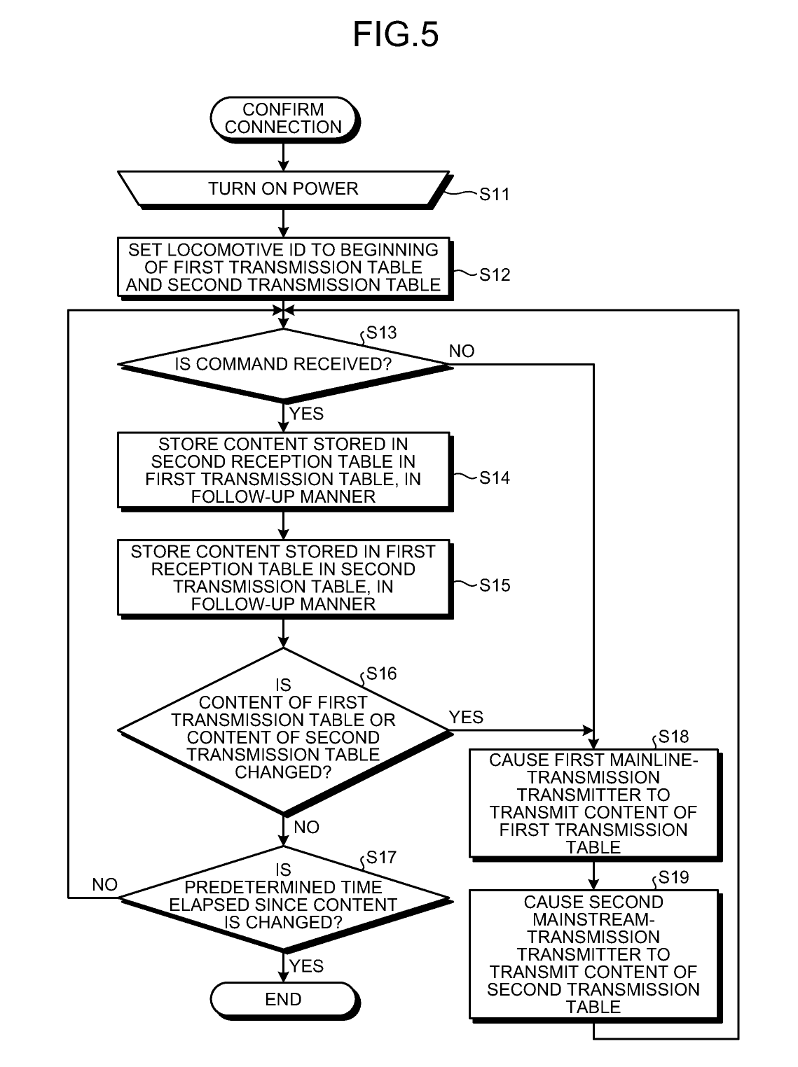

FIG. 5 is a flowchart of a processing of the present embodiment.

When power is turned on (step S11), the transmission relay device control apparatus 35 of the transmission core unit 21 installed in each of the locomotives 11-1 to 11-5 reads the locomotive ID stored in the memory 36, and set (store) the locomotive ID to (in) the beginning area of the first transmission table 51 and the beginning area of the second transmission table 53 (step S12).

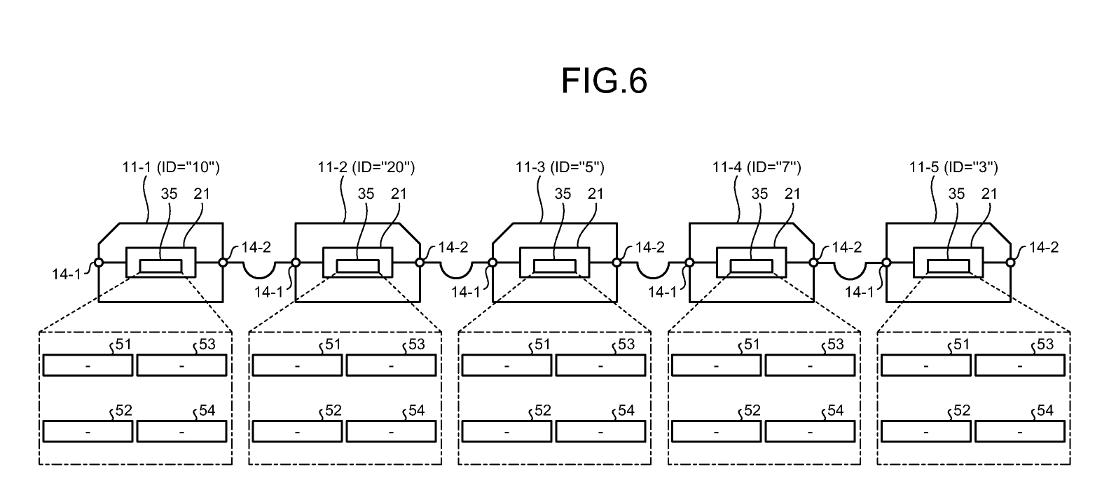

FIG. 6 is a view for explaining the states of the transmission table and the reception table immediately after the power is turned on.

Immediately after the power is turned on, the locomotives 11-1 to 11-5 are in their initial states at which no data is stored in the first transmission tables 51, the first reception tables 52, the second transmission tables 53, and the second reception tables 54.

Then, the transmission relay device control apparatus 35 of each of the locomotives 11-1 to 11-5 reads out the locomotive ID stored in the memory 36, and sets (stores) the locomotive ID to (in) the beginning area of the first transmission table 51 and the second transmission table 53.

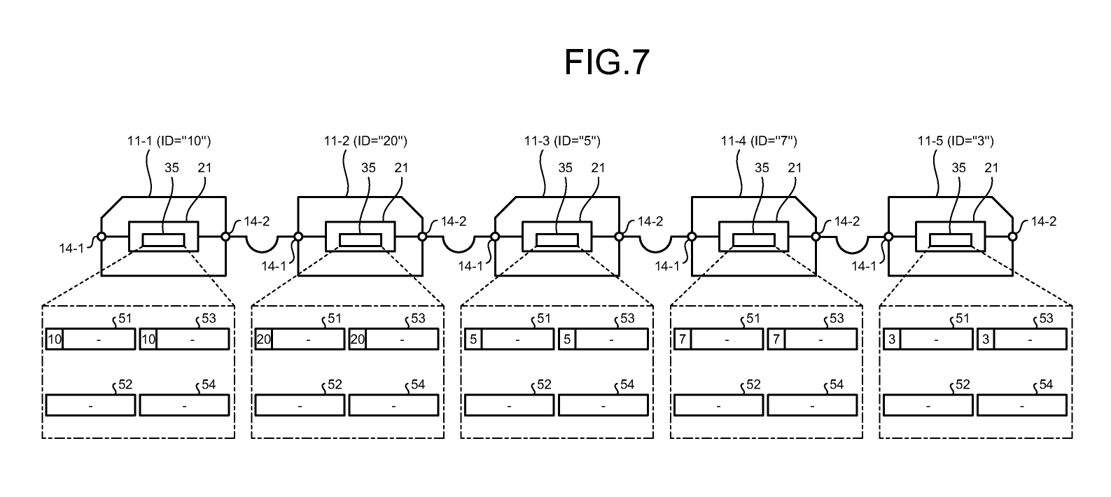

FIG. 7 is a view explaining states of the transmission table and the reception table after the locomotive IDs are set.

As illustrated in FIG. 7, the locomotive ID of “10” is stored in each of the beginning area of the first transmission table 51 of the locomotive 11-1 and the beginning area of the second transmission table 53 of the locomotive 11-1.

Similarly, the locomotive ID of “20” is stored in each of the beginning area of the first transmission table 51 of the locomotive 11-2 and the beginning area of the second transmission table 53 of the locomotive 11-2.

Further, the locomotive ID of “5” is stored in each of the beginning area of the first transmission table 51 of the locomotive 11-3 and the beginning area of the second transmission table 53 of the locomotive 11-3.

Further, the locomotive ID of “7” is stored in each of the beginning area of the first transmission table 51 of the locomotive 11-4 and the beginning area of the second transmission table 53 of the locomotive 11-4.

Further, the locomotive ID of “3” is stored in each of the beginning area of the first transmission table 51 of the locomotive 11-5 and the beginning area of the second transmission table 53 of the locomotive 11-5.

Next, the transmission relay device control apparatus 35 determines whether a connection confirmation command CMD11 or a connection confirmation command CMD12 is received from a transmission relay device control apparatus 35 installed in other locomotive (step S13).

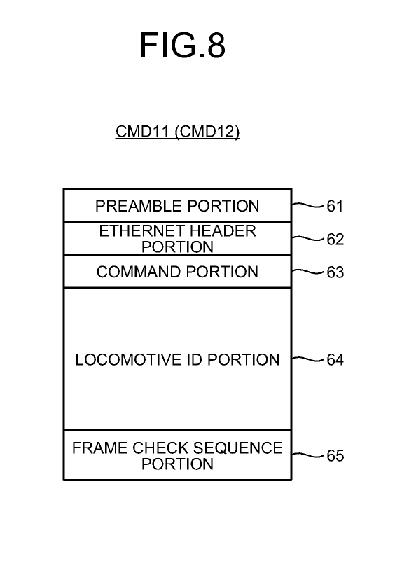

FIG. 8 is an explanatory view of a data format of the connection confirmation command. FIG. 8 is a data format of the connection confirmation command of when Ethernet (registered trademark) is used as the communication standard.

The connection confirmation command CMD11 and the connection confirmation command CMD12 have the same data format. Each of the connection confirmation command CMD11 and the connection confirmation command CMD12 includes: a preamble portion 61; an Ethernet header portion 62; a command portion 63; a locomotive ID portion; and a frame check sequence (FCS) portion 65, in this order. The preamble portion 61 is for the communication synchronization. The Ethernet header portion 62 stores therein a destination address, a source address, and the like. The command portion 63 indicates that it is the connection confirmation commands CMD11, CMD12. Regarding the connection confirmation command CMD11, the locomotive ID portion 64 stores therein the locomotive ID (group) including own locomotive ID stored in the first transmission table 51. Regarding the connection confirmation command CMD12, the locomotive ID portion 64 stores therein the locomotive ID (group) including own locomotive ID stored in the second transmission table. The FCS portion 65 stores therein a cyclic redundancy check (CRC) for error check.

When the connection confirmation command CMD11 is received from the first main transmitter 31 of other transmission relay device control apparatus 35 via the second main receiver 34, content of the locomotive ID portion of the connection confirmation command CMD11 is stored in the second reception table 54. Accordingly, the content of the locomotive ID portion 64 of the connection confirmation command CMD11 stored in the second reception table 54 is stored in the first transmission table 51 in follow-up manner (step S14).

Here, with respect to the same data, the storing in the follow-up manner means to overwrite and store the data (hereinafter, the same).

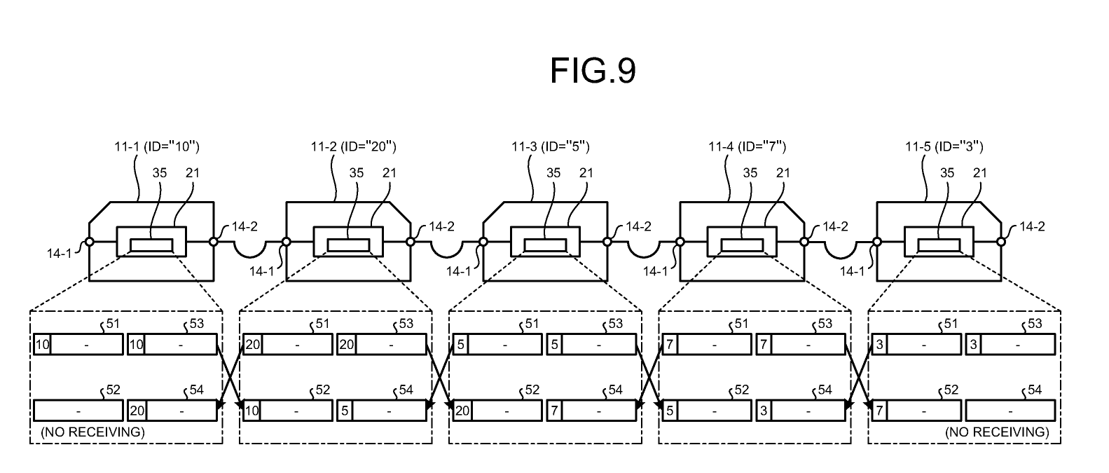

FIG. 9 is a view for explaining states of the transmission table and the reception table after the first connection confirmation command is received.

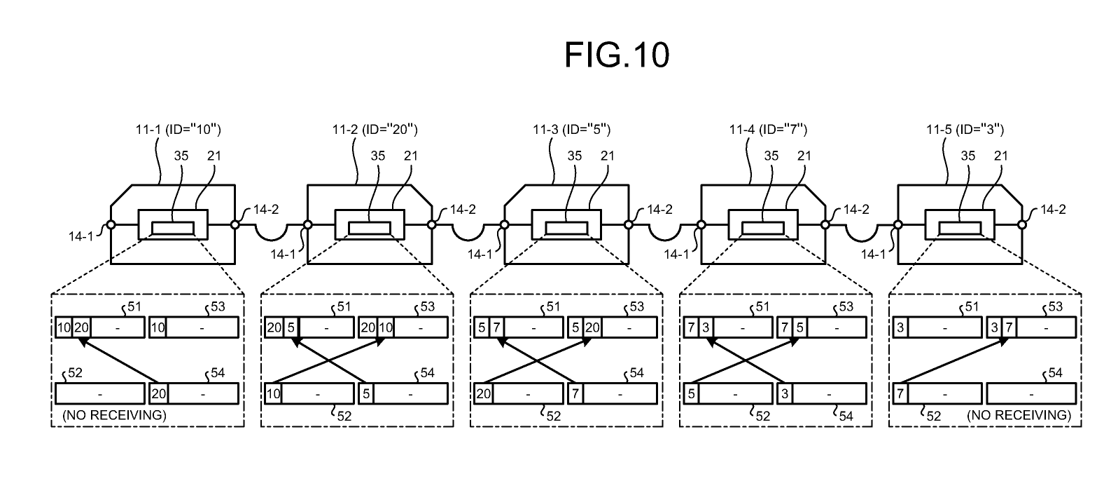

FIG. 10 is a view for explaining the states of the transmission table and the reception table after the first connection confirmation command is received and storing is performed in the follow-up manner.

In this state, only the locomotive ID of “20” of the locomotive 11-2 is stored in the first transmission table 51 of the locomotive 11-2 as illustrated in FIG. 9, for example. Therefore, the transmission relay device control apparatus 35 stores the locomotive ID of “5” stored in the second reception table 54 in the follow-up manner. As a result, as illustrated in FIG. 10, the locomotive IDs of “20” and “5” are stored in the first transmission table 51 of the locomotive 11-2.

Similarly, as illustrated in FIG. 10, the locomotive ID of “10” of the locomotive 11-1 and the locomotive ID of “20” of the locomotive 11-2 are stored in the first transmission table 51 of the locomotive 11-1.

Further, as illustrated in FIG. 10, the locomotive ID of “5” of the locomotive 11-3 and the locomotive ID of “7” of the locomotive 11-4 are stored in the first transmission table 51 of the locomotive 11-3.

Further, as illustrated in FIG. 10, the locomotive ID of “7” of the locomotive 11-4 and the locomotive ID of “3” of the locomotive 11-5 are stored in the first transmission table 51 of the locomotive 11-4.

Further, regarding the locomotive 11-5, there is no data received in the second reception table 54. Thus, as illustrated in FIG. 10, a state in which only the locomotive ID of “3” of the locomotive 11-5 is stored in the first transmission table 51 of the locomotive 11-5 is maintained.

Further, when the connection confirmation command CMD12 is received from the second main transmitter 33 of other transmission relay device control apparatus 35 via the first main receiver 32, the content of the locomotive ID portion of the connection confirmation command CMD12 is stored in the first reception table 52. Therefore, the transmission relay device control apparatus 35 stores the content of the locomotive ID portion of the connection confirmation command CMD12 stored in the first reception table 52 in the second transmission table 53, in the follow-up manner (step S15).

In this state, as illustrated in FIG. 9, only the locomotive ID of “20” of the locomotive 11-2 is stored in the second transmission table 53 of the locomotive 11-2, for example. Therefore, the transmission relay device control apparatus 35 stores the locomotive ID of “10” of the locomotive 11-1 stored in the first reception table 52, in the follow-up manner. As a result, as illustrated in FIG. 10, the locomotive IDs of “20” and “10” are stored in the second transmission table 53 of the locomotive 11-2.

Similarly, as illustrated in FIG. 10, the locomotive ID of “5” of the locomotive 11-3 and the locomotive ID of “20” of the locomotive 11-2 are stored in the second transmission table 53 of the locomotive 11-3.

Further, as illustrated in FIG. 10, the locomotive ID of “7” of the locomotive 11-4 and the locomotive ID of “5” of the locomotive 11-3 are stored in the second transmission table 53 of the locomotive 11-4.

Further, as illustrated in FIG. 10, the locomotive ID of “3” of the locomotive 11-5 and the locomotive ID of “7” of the locomotive 11-4 are stored in the second transmission table 53 of the locomotive 11-5.

Further, regarding the locomotive 11-1, there is no data received in the first reception table 52. Therefore, as illustrated in FIG. 10, a state in which only the locomotive ID of “10” of the locomotive 11-1 is stored in the second transmission table 53 of the locomotive 11-1 is maintained.

Next, the transmission relay device control apparatus 35 determines whether the content of the first transmission table 51 or the content of the second transmission table 53 is changed (step S16).

At the determination of step S16 in the above-mentioned example, it is determined that the content of the first transmission table 51 or the content of the second transmission table 53 is changed for all of the locomotives 11-1 to 11-5 (Yes at step S16). Therefore, the transmission relay device control apparatus 35 of each of the locomotives 11-1 to 11-5 transmits the content of the first transmission table 51 from the first main transmitter 31 as a second connection confirmation command CMD11 (step S18).

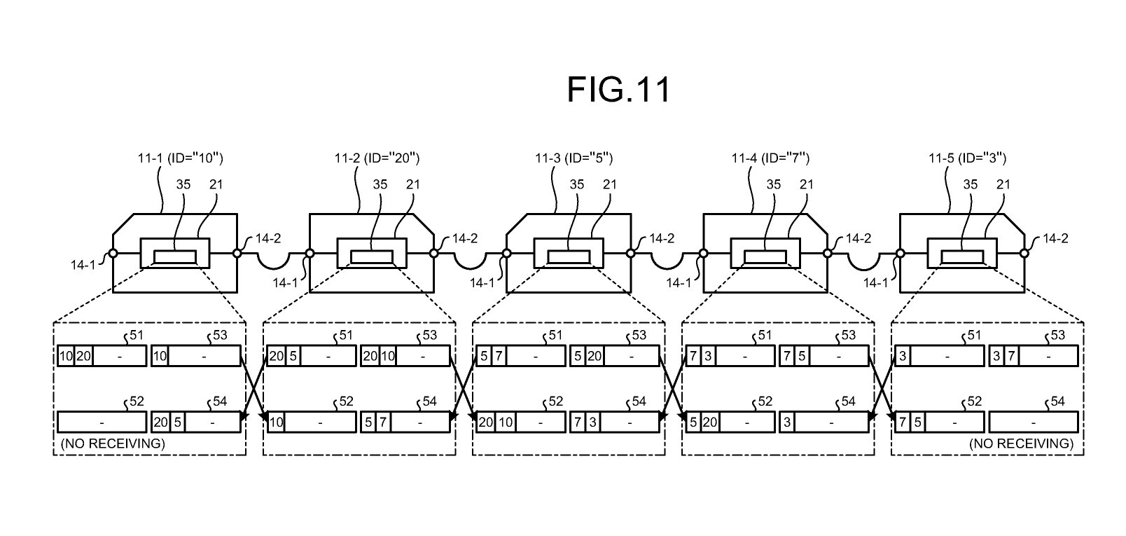

FIG. 11 is a view for explaining the states of the transmission table and the reception table after the second connection confirmation command is received.

Here, although other locomotive has not been connected to the first connector 14-1, the transmission relay device control apparatus 35 of the locomotive 11-1 transmits the locomotive ID of “10” of the locomotive 11-1 and the locomotive ID of “20” of the locomotive 11-2 stored in the first transmission table 51 from the first main transmitter 34 as the connection confirmation command CMD11.

On the other hand, the transmission relay device control apparatus 35 of the locomotive 11-2 causes the first main transmitter 31 to transmit, toward the locomotive 11-1, the locomotive ID of “20” of the locomotive 11-2 and the locomotive ID of “5” of the locomotive 11-3 stored in the first transmission table 51, as the connection confirmation command CMD11. Consequently, as illustrated in FIG. 11, the locomotive ID of “5” of the locomotive 11-3 is stored in the second reception table 54 of the locomotive 11-1 in the follow-up manner, and the locomotive IDs of “20” and “5” are stored.

Further, the transmission relay device control apparatus 35 of the locomotive 11-3 causes the first main transmitter 31 to transmit, toward the locomotive 11-2, the locomotive ID of “5” of the locomotive 11-3 and the locomotive ID of “7” of the locomotive 11-4 stored in the first transmission table 51, as the connection confirmation command CMD11. Consequently, as illustrated in FIG. 11, the locomotive ID of “7” of the locomotive 11-4 is stored in the second reception table 54 of the locomotive 11-2 in the follow-up manner, and the locomotive IDs of “5” and “7” are stored.

Further, the transmission relay device control apparatus 35 of the locomotive 11-4 causes the first main transmitter 31 to transmit, toward the locomotive 11-3, the locomotive ID of “7” of the locomotive 11-4 and the locomotive ID of “3” of the locomotive 11-5 stored in the first transmission table 51, as the connection confirmation command CMD11. Consequently, as illustrated in FIG. 11, the locomotive ID of “3” of the locomotive 11-5 is stored in the second reception table 54 of the locomotive 11-3 in the follow-up manner, and the locomotive IDs of “7” and “3” are stored.

Further, the transmission relay device control apparatus 35 of the locomotive 11-5 causes the first main transmitter 31 to transmit, toward the locomotive 11-4, the locomotive ID of “3” of the locomotive 11-5, which is stored in the first transmission table 51, as the connection confirmation command CMD11. However, as illustrated in FIG. 11, the content of the second reception table 54 of the locomotive 11-4 does not change.

Subsequently, the transmission relay device control apparatus 35 of each of the locomotives 11-1 to 11-5 causes the second main transmitter 33 to transmit the content of the second transmission table 53 as the connection confirmation command CMD12 (step S19).

That is to say, the transmission relay device control apparatus 35 of the locomotive 11-1 causes the second main transmitter 33 to transmit, toward the locomotive 11-2, the connection confirmation command CMD12 including the locomotive ID of “10” of the locomotive 11-1 stored in the second transmission table 53. Consequently, the locomotive ID of “10” of the locomotive 11-1 is stored in the first reception table 52 of the locomotive 11-2.

Similarly, the transmission relay-device control apparatus 35 of the locomotive 11-2 causes the second main transmitter 33 to transmit, toward the locomotive 11-3, the connection confirmation command CMD12 including the locomotive ID of “20” of the locomotive 11-2 and the locomotive ID of “10” of the locomotive 11-1 stored in the second transmission table 53. Consequently, as illustrated in FIG. 11, the locomotive IDs of “20” and “10” are stored in the first reception table 52 of the locomotive 11-3.

Similarly, the transmission relay-device control apparatus 35 of the locomotive 11-3 causes the second main transmitter 33 to transmit, toward the locomotive 11-4, the connection confirmation command CMD12 including the locomotive ID of “5” of the locomotive 11-3 and the locomotive ID of “20” of the locomotive 11-2 stored in the second transmission table 53. Consequently, as illustrated in FIG. 11, the locomotive IDs of “5” and “20” are stored in the first reception table 52 of the locomotive 11-4.

Similarly, the transmission relay-device control apparatus 35 of the locomotive 11-4 causes the second main transmitter 33 to transmit, toward the locomotive 11-5, the connection confirmation command CMD12 including the locomotive ID of “7” of the locomotive 11-4 and the locomotive ID of “5” of the locomotive 11-3 stored in the second transmission table 53. Consequently, as illustrated in FIG. 11, the locomotive IDs of “7” and “5” are stored in the first reception table 52 of the locomotive 11-5.

Further, the transmission relay device control apparatus 35 of the locomotive 11-5 causes the second main transmitter 33 to send the connection confirmation command CMD12 including the locomotive ID of “3” of the locomotive 11-5 stored in the second transmission table 53.

Next, the processing of the transmission relay device control apparatus 35 of the locomotives 11-1 to 11-5 shifts back to step S13.

Then, the transmission relay device control apparatus 35 of the locomotives 11-1 to 11-5 determines again whether the connection confirmation command CMD11 or the connection confirmation command CMD12 is received from the transmission relay device control apparatus 35 installed in other locomotive (step S13).

Then, if it is determined that the connection confirmation command CMD11 is received from the first main transmitter 31 of other transmission relay device control apparatus 35 via the second main receiver 34, the content of the locomotive ID portion of the connection confirmation command CMD11 is to be stored in the second reception table 54. Accordingly, the content of the locomotive ID portion of the connection confirmation command CMD11 stored in the second reception table 54 is stored in the first transmission table 51, in the follow-up manner (step S14).

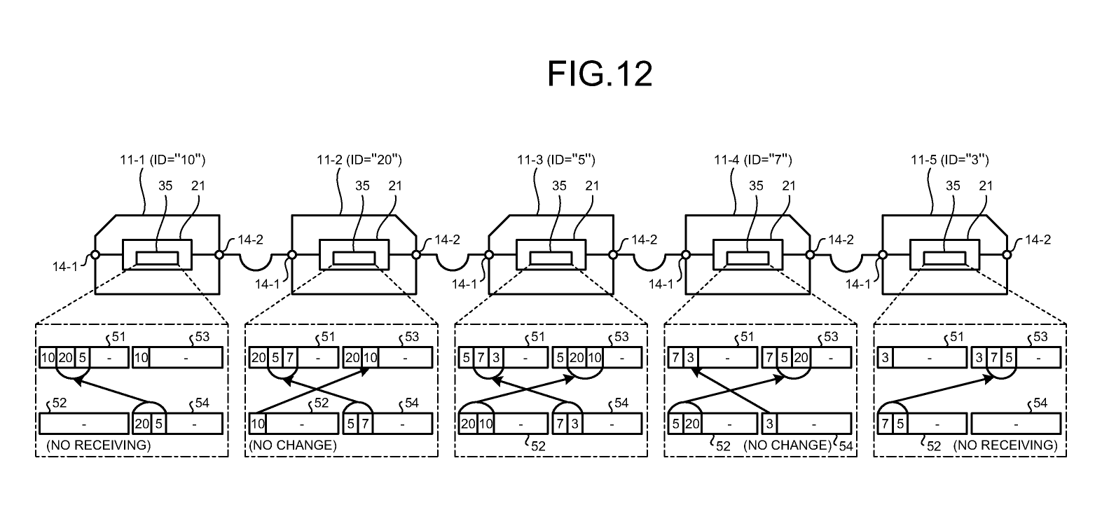

FIG. 12 is a view for explaining the states of the transmission table and the reception table after the second connection confirmation command is received and the storing in the follow-up manner is performed.

In this state, as illustrated in FIG. 11, the locomotive ID of “20” of the locomotive 11-2 and the locomotive ID of “5” of the locomotive 11-3 are stored in the first transmission table 51 of the locomotive 11-2, for example. Therefore, the transmission relay device control apparatus 35 stores the locomotive ID of “7” of the locomotive 11-4 stored in the second reception table 54, in the follow-up manner. As a result, as illustrated in FIG. 12, the locomotive IDs of “20”, “5”, and “7” are stored in the first transmission table 51 of the locomotive 11-2.

Similarly, as illustrated in FIG. 11, the locomotive ID of “10” of the locomotive 11-1 and the locomotive ID of “20” of the locomotive 11-2 are stored in the first transmission table 51 of the locomotive 11-1. Therefore, the transmission relay device control apparatus 35 stores the locomotive ID of “5” of the locomotive 11-3 stored in the second reception table 54, in the follow-up manner. As a result, as illustrated in FIG. 12, the locomotive IDs of “10”, “20”, and “5” are stored in the first transmission table 51 of the locomotive 11-1.

Further, as illustrated in FIG. 11, the locomotive ID of “5” of the locomotive 11-3 and the locomotive ID of “7” of the locomotive 11-4 are stored in the first transmission table 51 of the locomotive 11-3. Therefore, the transmission relay device control apparatus 35 stores the locomotive ID of “3” of the locomotive 11-5 stored in the second reception table 54, in the follow-up manner. As a result, as illustrated in FIG. 12, the locomotive IDs of “5”, “7”, and “3” are stored in the first transmission table 51 of the locomotive 11-3.

Further, although the locomotive ID of “7” of the locomotive 11-4 and the locomotive ID of “3” of the locomotive 11-5 are stored in the first transmission table 51 of the locomotive 11-4, there is no data newly received in the second reception table 54 of the locomotive 11-4. Therefore, the first transmission table 51 of the locomotive 11-4 is maintained in a state in which the locomotive ID of “7” of the locomotive 11-4 and the locomotive ID of “3” of the locomotive 11-5 are stored.

Further, there is no data newly received in the second reception table 54 of the locomotive 11-5. Therefore, the first transmission table 51 of the locomotive 11-5 is maintained in a state in which only the locomotive ID of “3” of the locomotive 11-5 is stored.

Further, when the connection confirmation command CMD12 is received from the second main transmitter 33 of other transmission relay device control apparatus 35 via the first main receiver 32, the content of the locomotive ID portion of the connection confirmation command CMD12 is to be stored in the first reception table 52. Thus, the transmission relay device control apparatus 35 stores the content of the locomotive ID portion of the connection confirmation command CMD12 stored in the first reception table 52 into the second transmission table 53, in the follow-up manner (step S15).

In this state, there is no data received in the first reception table 52 of the locomotive 11-1. Therefore, as illustrated in FIG. 12, the second transmission table 53 of the locomotive 11-1 is maintained in a state in which only the locomotive ID of “10” of the locomotive 11-1 is stored.

Further, as illustrated in FIG. 11, although the locomotive ID of “20” of the locomotive 11-2 and the locomotive ID of “10” of the locomotive 11-1 are stored in the second transmission table 53 of the locomotive 11-2, there is no data newly received in the first reception table 52 of the locomotive 11-2. Therefore, as illustrated in FIG. 12, the second transmission table 53 of the locomotive 11-2 is maintained in a state in which the locomotive ID of “20” of the locomotive 11-2 and the locomotive ID of “10” of the locomotive 11-1 are stored.

Further, as illustrated in FIG. 11, the locomotive ID of “5” of the locomotive 11-3 and the locomotive ID of “20” of the locomotive 11-2 are stored in the second transmission table 53 of the locomotive 11-3. Therefore, the transmission relay device control apparatus 35 stores the locomotive ID of “10” of the locomotive 11-1 stored in the first reception table 52, in the follow-up manner. As a result, as illustrated in FIG. 12, the locomotive IDs of “5”, “20”, and “10” are stored in the second transmission table 53 of the locomotive 11-3.

Further, as illustrated in FIG. 11, the locomotive ID of “7” of the locomotive 11-4 and the locomotive ID of “5” of the locomotive 11-3 are stored in the second transmission table 53 of the locomotive 11-4. Therefore, the transmission relay device control apparatus 35 stores the locomotive ID of “20” of the locomotive 11-2 stored in the first reception table 52, in the follow-up manner. As a result, as illustrated in FIG. 12, the locomotive IDs “7”, “5”, and “20” are stored in the second transmission table 53 of the locomotive 11-4.

Further, as illustrated in FIG. 11, the locomotive ID of “3” of the locomotive 11-5 and the locomotive ID of “7” of the locomotive 11-4 are stored in the second transmission table 53 of the locomotive 11-5. Therefore, the transmission relay device control apparatus 35 stores the locomotive ID of “5” of the locomotive 11-3 stored in the first reception table 52, in the follow-up manner. As a result, as illustrated in FIG. 12, the locomotive IDs of “3”, “7”, and “5” are stored in the second transmission table 53 of the locomotive 11-5.

Next, the transmission relay device control apparatus 35 determines whether the content of the first transmission table 51 or the content of the second transmission table 53 is changed (step S16).

In the above example, as a result of the determination of step S16, it is determined that the content of the first transmission table 51 or the content of the second transmission table 53 is changed for all of the locomotives 11-1 to 11-5 (Yes at step S16). Therefore, the transmission relay device control apparatus 35 of each of the locomotives 11-1 to 11-5 causes the first main transmitter 31 to send the content of the first transmission table 51 as the connection confirmation command CMD11 (step S18).

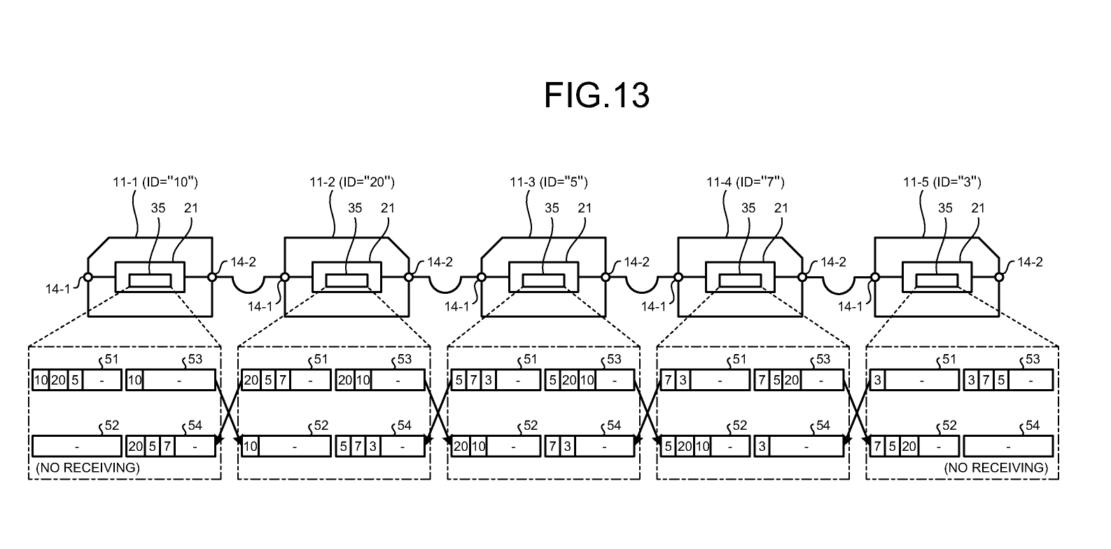

FIG. 13 is a view for explaining the states of the transmission table and the reception table after a third connection confirmation command is received.

Similarly, although the first connector 14-1 is not connected to other locomotive, the transmission relay device control apparatus 35 of the locomotive 11-1 transmits, from the first main transmitter 31, the locomotive ID of “10” of the locomotive 11-1, the locomotive ID of “20” of the locomotive 11-2, and the locomotive ID of “5” of the locomotive 11-3, as the connection confirmation command CMD11.

On the other hand, the transmission relay device control apparatus 35 of the locomotive 11-2 causes the first main transmitter 31 to transmit, toward the locomotive 11-1, the locomotive ID of “20” of the locomotive 11-2, the locomotive ID of “5” of the locomotive 11-3, and the locomotive ID of “7” of the locomotive 11-4, as the connection confirmation command CMD11.

Further, the transmission relay device control apparatus 35 of the locomotive 11-3 causes the first main transmitter 31 to transmit, toward the locomotive 11-2, the locomotive ID of “5” of the locomotive 11-3, the locomotive ID of “7” of the locomotive 11-4, and the locomotive ID of “3” of the locomotive 11-5, as the connection confirmation command CMD11.

Further, the transmission relay device control apparatus 35 of the locomotive 11-4 causes the first main transmitter 31 to transmit, toward the locomotive 11-3, the locomotive ID of “7” of the locomotive 11-4 and the locomotive ID of “3” of the locomotive 11-5, as the connection confirmation command CMD11.

Further, the transfer relay device control apparatus 35 of the locomotive 11-5 causes the first main transmitter 31 to transmit, toward the locomotive 11-4, the locomotive ID of “3” of the locomotive 11-5, as the connection confirmation command CMD11.

Subsequently, the transmission relay device control apparatus 35 of each of the locomotives 11-1 to 11-5 causes the second main transmitter 33 to transmit the content of the second transmission table 53 as the connection confirmation command CMD12 (step S19).

That is to say, the transmission relay device control apparatus 35 of the locomotive 11-1 causes the second main transmitter 33 to transmit, toward the locomotive 11-2, the locomotive ID of “10” of the locomotive 11-1 stored in the second transmission table 53, as the connection confirmation command CMD12.

Similarly, the transmission relay device control apparatus 35 of the locomotive 11-2 causes the second main transmitter 33 to transmit, toward the locomotive 11-3, the locomotive ID of “20” of the locomotive 11-2 and the locomotive ID of “10” of the locomotive 11-1 stored in the second transmission table 53, as the connection confirmation command CMD12.

Further, the transmission relay device control apparatus 35 of the locomotive 11-3 causes the second main transmitter 33 to transmit, toward the locomotive 11-4, the locomotive ID of “5” of the locomotive 11-3, the locomotive ID of “20” of the locomotive 11-2, and the locomotive ID of “10” of the locomotive 11-1 stored in the second transmission table 53, as the connection confirmation command CMD12.

Further, the transmission relay device control apparatus 35 of the locomotive 11-4 causes the second main transmitter 33 to transmit, toward the locomotive 11-5, the locomotive ID of “7” of the locomotive 11-4, the locomotive ID of “5” of the locomotive 11-3, and the locomotive ID of “20” of the locomotive 11-2 stored in the second transmission table 53, as the connection confirmation command CMD12.

Further, the transmission relay device control apparatus 35 of the locomotive 11-5 causes the second main transmitter 33 to transmit the locomotive ID of “3” of the locomotive 11-5, the locomotive ID of “7” of the locomotive 11-4, and the locomotive ID of “5” of the locomotive 11-3 stored in the second transmission table 53, as the connection confirmation command CMD12.

Subsequently, the processing of the transmission relay device control apparatus 35 of the locomotives 11-1 to 11-5 is shifted again to step S13.

Then, the transmission relay device control apparatus 35 of the locomotives 11-1 to 11-5 again determines whether the connection confirmation command CMD11 or the connection confirmation command CMD12 is received from the transmission relay device control apparatus 35 installed in other locomotive (step S13).

Then, when the connection confirmation command CMD11 is received from the first main transmitter 31 of other transmission relay device control apparatus 35 via the second main receiver 34, the content of the locomotive ID portion of the connection confirmation command CMD11 is to be stored in the second reception table 54. Thus, the content of the locomotive ID portion of the connection confirmation command CMD11 stored in the second reception table 54 is stored in the first transmission table 51, in the follow-up manner (step S14).

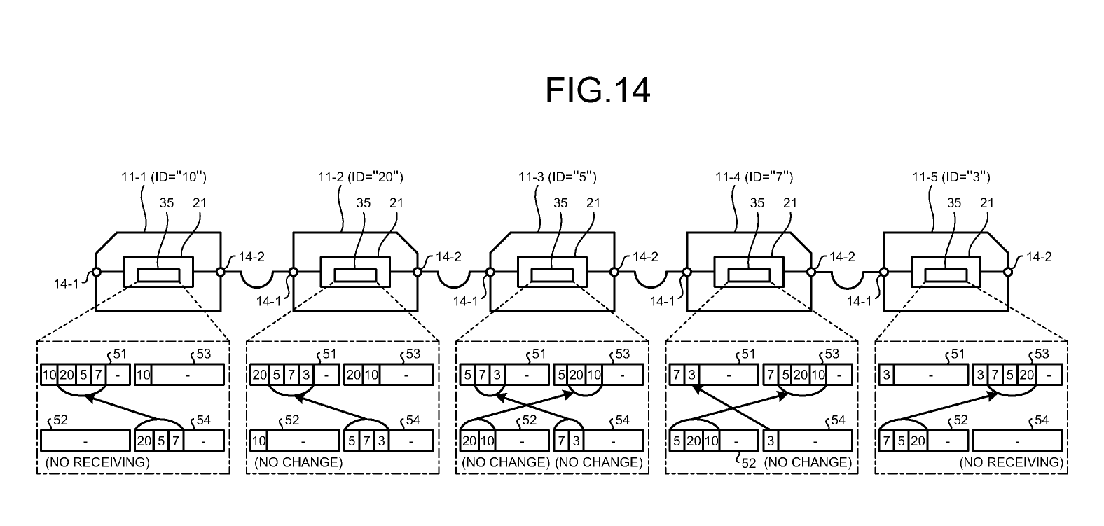

FIG. 14 is a view for explaining the state of the transmission table and the reception table after a third connection confirmation command is received and storing is performed in the follow-up manner.

In this state, as illustrated in FIG. 13, the locomotive ID of “20” of the locomotive 11-2, the locomotive ID of “5” of the locomotive 11-3, and the locomotive ID of “7” of the locomotive 11-4, are stored in the first transmission table 51 of the locomotive 11-2, for example. Therefore, the transmission relay device control apparatus 35 stores the locomotive ID of “3” of the locomotive 11-5 stored in the second reception table 54, in the follow-up manner. As a result, as illustrated in FIG. 14, the locomotive IDs of “20”, “5”, “7”, and “3” are stored in the first transmission table 51 of the locomotive 11-2.

Similarly, as illustrated in FIG. 13, the locomotive ID of “10” of the locomotive 11-1, the locomotive ID of “20” of the locomotive 11-2, and the locomotive ID of “5” of the locomotive 11-3, are stored in the first transmission table 51 of the locomotive 11-1. Therefore, the transfer relay device control apparatus 35 stores the locomotive ID of “7” of the locomotive 11-4 stored in the second reception table 54, in the follow-up manner. As a result, as illustrated in FIG. 14, the locomotive IDs “10”, “20”, “5”, and “7” are stored in the first transmission table 51 of the locomotive 11-1.

Further, as illustrated in FIG. 13, the locomotive ID of “5” of the locomotive 11-3, the locomotive ID of “7” of the locomotive 11-4, and the locomotive ID of “3” of the locomotive 11-5 are stored in the first transmission table 51 of the locomotive 11-3. However, there is no data newly received in the second reception table 54 of the locomotive 11-3. Therefore, the first transmission table 51 of the locomotive 11-3 is maintained in a state in which the locomotive ID of “5” of the locomotive 11-3, the locomotive ID of “7” of the locomotive 11-4, and the locomotive ID of “3” of the locomotive 11-5 are stored.

Further, as illustrated in FIG. 13, the locomotive ID of “7” of the locomotive 11-4 and the locomotive ID of “3” of the locomotive 11-5 are stored in the first transmission table 51 of the locomotive 11-4. However, there is no data newly received in the second reception table 54 of the locomotive 11-4. Therefore, the first transmission table 51 of the locomotive 11-4 is maintained in a state in which the locomotive ID of “7” of the locomotive 11-4 and the locomotive ID of “3” of the locomotive 11-5 are stored.

Further, since there is no data received in the second reception table 54 of the locomotive 11-5, the first transmission table 51 of the locomotive 11-5 is maintained in a state in which only the locomotive ID of “3” of the locomotive 11-5 is stored.

Further, when the connection confirmation command CMD12 is received from the second main transmitter 33 of other transmission relay device control apparatus 35 via the first main receiver 32, the content of the locomotive ID portion of the connection confirmation command CMD12 is stored in the first reception table 52. Therefore, the transmission relay device control apparatus 35 stores the content of the locomotive ID portion of the connection confirmation command CMD12 stored in the first reception table 52 in the second transmission table 53, in the follow-up manner (step S15).

In this state, there is no data received in the first reception table 52 of the locomotive 11-1. Thus, as illustrated in FIG. 14, the second transmission table 53 of the locomotive 11-1 is maintained in a state in which only the locomotive ID of “10” of the locomotive 11-1 is stored.

Further, as illustrated in FIG. 13, the locomotive ID of “20” of the locomotive 11-2 and the locomotive ID of “10” of the locomotive 11-1 are stored in the second transmission table 53 of the locomotive 11-2. On the other hand, there is no data newly received in the first reception table 52 of the locomotive 11-2. Therefore, as illustrated in FIG. 14, the second transmission table 53 of the locomotive 11-2 is maintained in a state in which the locomotive ID of “20” of the locomotive 11-2 and the locomotive ID of “10” of the locomotive 11-1 are stored.

Further, as illustrated in FIG. 13, the locomotive ID of “5” of the locomotive 11-3, the locomotive ID of “20” of the locomotive 11-2, and the locomotive ID of “10” of the locomotive 11-1 are stored in the second transmission table 53 of the locomotive 11-3. On the other hand, there is no data newly received in the first reception table 52 of the locomotive 11-3. Therefore, as illustrated in FIG. 14, the second transmission table 53 of the locomotive 11-2 is maintained in a state in which the locomotive ID of “5” of the locomotive 11-3, the locomotive ID of “20” of the locomotive 11-2 and the locomotive ID of “10” of the locomotive 11-1 are stored.

Further, as illustrated in FIG. 13, the locomotive ID of “7” of the locomotive 11-4, the locomotive ID of “5” of the locomotive 11-3, and the locomotive ID of “20” of the locomotive 11-2 are stored in the second transmission table 53 of the locomotive 11-4. Therefore, the transmission relay device control apparatus 35 stores the locomotive ID of “10” of the locomotive 11-1 11 12 stored in the first reception table 52, in the follow-up manner. As a result, as illustrated in FIG. 14, the locomotive IDs of “7”, “5”, “20”, and “10” are stored in the second transmission table 53 of the locomotive 11-4.

Further, as illustrated in FIG. 13, the locomotive ID of “3” of the locomotive 11-5, the locomotive ID of “7” of the locomotive 11-4, and the locomotive ID of “5” of the locomotive 11-3 are stored in the second transmission table 53 of the locomotive 11-5. Therefore, the transmission relay device control apparatus 35 stores the locomotive ID of “20” of the locomotive 11-2 stored in the first reception table 52, in the follow-up manner. As a result, as illustrated in FIG. 14, the locomotive IDs of “3”, “7”, “5”, and “20” are stored in the second transmission table 53 of the locomotive 11-5.

Next, the transmission relay device control apparatus 35 determines whether the content of the first transmission table 51 or the content of the second transmission table 53 is changed (step S16).

In the determination of step S16 of the above-mentioned example, it is determined that the content of the first transmission table 51 or the content of the second transmission table 53 is changed for all of the locomotives 11-1 to 11-5 (Yes at step S16). Therefore, the transmission relay device control apparatus 35 of each of the locomotives 11-1 to 11-5 causes the first main transmitter 31 to send the content of the first transmission table 51 as the connection confirmation command CMD11 (step S18).

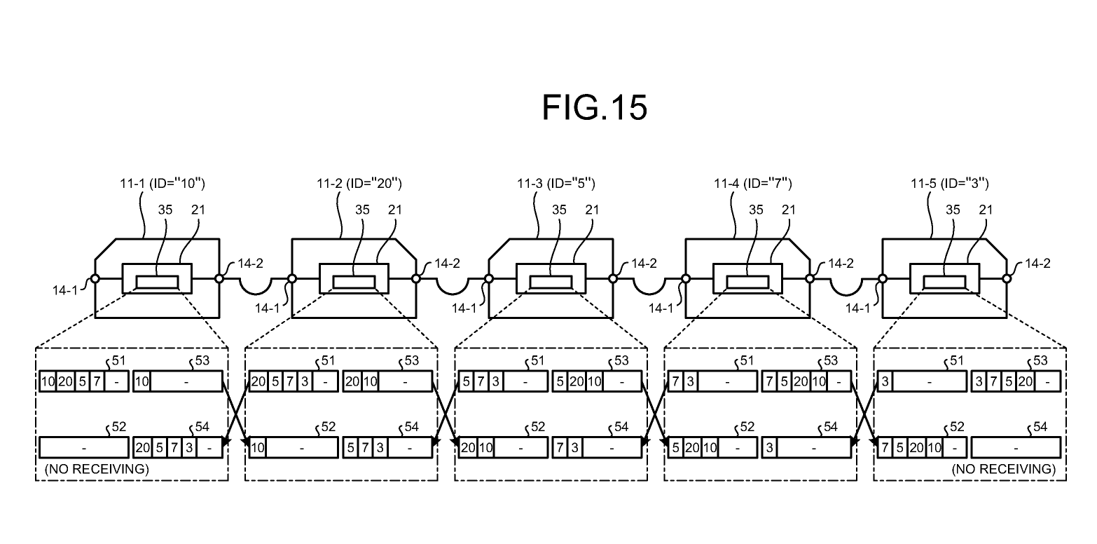

FIG. 15 is a view for explaining the states of the transmission table and the reception table after a fourth connection confirmation command is received.

Here, as similar to the above, the transmission relay device control apparatus 35 of the locomotive 11-1 transmits the locomotive ID of “10” of the locomotive 11-1, the locomotive ID of “20” of the locomotive 11-2, the locomotive ID of “5” of the locomotive 11-3, and the locomotive ID of “7” of the locomotive 11-4 stored in the first transmission table 51, from the first main transmitter 31, as the connection confirmation command CMD11.

On the other hand, the transmission relay device control apparatus of the locomotive 11-2 causes the first main transmitter 31 to transmit, toward the locomotive 11-1, the locomotive ID of “20” of the locomotive 11-2, the locomotive ID of “5” of the locomotive 11-3, the locomotive ID of “7” of the locomotive 11-4, and the locomotive ID of “3” of the locomotive 11-5 stored in the first transmission table 51, as the connection confirmation command CMD11.

Further, the transmission relay device control apparatus 35 of the locomotive 11-3 causes the first main transmitter 31 to transmit, toward the locomotive 11-2, the locomotive ID of “5” of the locomotive 11-3, the locomotive ID of “7” of the locomotive 11-4, and the locomotive ID of “3” of the locomotive 11-5 stored in the first transmission table 51, as the connection confirmation command CMD11.

Further, the transmission relay device control apparatus 35 of the locomotive 11-4 causes the first main transmitter 31 to transmit, toward the locomotive 11-3, the locomotive ID of “7” of the locomotive 11-4 and the locomotive ID of “3” of the locomotive 11-5, stored in the first transmission table 51, as the connection confirmation command CMD11.

Further, the transmission relay device control apparatus 35 of the locomotive 11-5 causes the first main transmitter 31 to transmit, toward the locomotive 11-4, the locomotive ID of “3” of the locomotive 11-5 stored in the first transmission table 51 as the connection confirmation command CMD11.

Subsequently, the transmission relay device control apparatus 35 of each of the locomotives 11-1 to 11-5 causes the second main transmitter 33 to transmit the content of the second transmission table 53 (step S19).

That is to say, the transmission relay device control apparatus 35 of the locomotive 11-1 causes the second main transmitter 33 to transmit, toward the locomotive 11-2, the locomotive ID of “10” of the locomotive 11-1 stored in the second transmission table 53 as the connection confirmation command CMD12.

Similarly, the transmission relay device control apparatus 35 of the locomotive 11-2 causes the second main transmitter 33 to transmit, toward the locomotive 11-3, the locomotive ID of “20” of the locomotive 11-2 and the locomotive ID of “10” of the locomotive 11-1 stored in the second transmission table 53 as the connection confirmation command CMD12.

Further, the transmission relay device control apparatus 35 of the locomotive 11-3 causes the second main transmitter 33 to transmit, toward the locomotive 11-4, the locomotive ID of “5” of the locomotive 11-3, the locomotive ID of “20” of the locomotive 11-2, and the locomotive ID of “10” of the locomotive 11-1 stored in the second transmission table 53 as the connection confirmation command CMD12.

Further, the transmission relay device control apparatus 35 of the locomotive 11-4 causes the second main transmitter 33 to transmit, toward the locomotive 11-5, the locomotive ID of “7” of the locomotive 11-4, the locomotive ID of “5” of the locomotive 11-3, the locomotive ID of “20” of the locomotive 11-2, and the locomotive ID of “10” of the locomotive 11-1 stored in the second transmission table 53 as the connection confirmation command CMD12.

Further, the transmission relay device control apparatus 35 of the locomotive 11-5 causes the second main transmitter 33 to transmit the locomotive ID of “3” of the locomotive 11-5, the locomotive ID of “7” of the locomotive 11-4, the locomotive ID of “5” of the locomotive 11-3, and the locomotive ID of “20” of the locomotive 11-2 stored in the second transmission table 53 as the connection confirmation command CMD12.

Subsequently, the processing of the transmission relay device control apparatus 35 of the locomotives 11-1 to 11-5 again shifts to step S13.

Then, the transmission relay device control apparatus 35 of the locomotives 11-1 to 11-5 determines again whether the connection confirmation command CMD11 or the connection confirmation command CMD12 is received from the transmission relay device control apparatus 35 installed in other locomotive (step S13).

Then, when the connection confirmation command CMD11 is received from the first main transmitter 31 of other transmission relay device control apparatus 35 via the second main receiver 34, the content of the locomotive ID portion of the connection confirmation command CMD11 is stored in the second reception table 54. Therefore, the content of the locomotive ID portion of the connection confirmation command CMD11 stored in the second reception table 54 is stored in the first transmission table 51, in the follow-up manner (step S14).

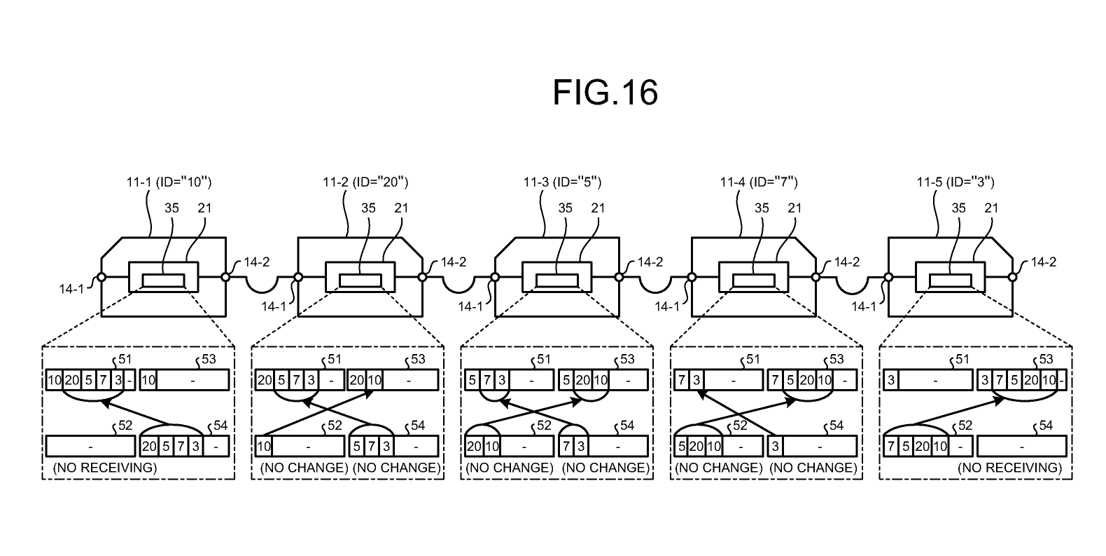

FIG. 16 is a view for explaining the states of the transmission table and the reception table after a forth connection confirmation command is received and storing is performed in the follow-up manner.

In this state, as illustrated in FIG. 15, the locomotive ID of “20” of the locomotive 11-2, the locomotive ID of “5” of the locomotive 11-3, the locomotive ID of “7” of the locomotive 11-4, and the locomotive ID of “3” of the locomotive 11-5 are stored in the first transmission table 51 of the locomotive 11-2, for example. However, there is no data newly received in the second reception table 54 of the locomotive 11-2. Therefore, the first transmission table 51 of the locomotive 11-2 is maintained in a state in which the locomotive ID of “20” of the locomotive 11-2, the locomotive ID of “5” of the locomotive 11-3, the locomotive ID of “7” of the locomotive 11-4, and the locomotive ID of “3” of the locomotive 11-5 are stored.

Similarly, as illustrated in FIG. 15, the locomotive ID of “10” of the locomotive 11-1, the locomotive ID of “20” of the locomotive 11-2, the locomotive ID of “5” of the locomotive 11-3, and the locomotive ID of “7” of the locomotive 11-4 are stored in the first transmission table 51 of the locomotive 11-1. Therefore, the transmission relay device control apparatus 35 stores the locomotive ID of “3” of the locomotive 11-5 stored in the second reception table 54, in the follow-up manner. As a result, as illustrated in FIG. 16, the locomotive IDs of “10”, “20”, “5”, “7”, and “3” are stored in the first transmission table 51 of the locomotive 11-1.

Further, as illustrated in FIG. 15, the locomotive ID of “5” of the locomotive 11-3, the locomotive ID of “7” of the locomotive 11-4, and the locomotive ID of “3” of the locomotive 11-5 are stored in the first transmission table 51 of the locomotive 11-3. However, there is no data newly received in the second reception table 54 of the locomotive 11-3. Therefore, the first transmission table 51 of the locomotive 11-3 is maintained in a state in which the locomotive ID of “5” of the locomotive 11-3, the locomotive ID of “7” of the locomotive 11-4, and the locomotive ID of “3” of the locomotive 11-5 are stored.

Further, as illustrated in FIG. 15, the locomotive ID of “7” of the locomotive 11-4 and the locomotive ID of “3” of the locomotive 11-5 are stored in the first transmission table 51 of the locomotive 11-4. However, there is no data newly received in the second reception table 54 of the locomotive 11-4. Therefore, the first transmission table 51 of the locomotive 11-4 is maintained in a state in which the locomotive ID of “7” of the locomotive 11-4 and the locomotive ID of “3” of the locomotive 11-5 are stored.

Further, there is no data received in the second reception table 54 of the locomotive 11-5. Therefore, the first transmission table 51 of the locomotive 11-5 is maintained in a state in which only the locomotive ID of “3” is stored.

Further, when the connection confirmation command CMD12 is received from the second main transmitter 33 of other transmission relay device control apparatus 35 via the first main receiver 32, the content of the locomotive ID portion of the connection confirmation command CMD12 is stored in the first reception table 52. Therefore, the transmission relay device control apparatus 35 stores the content of the locomotive ID portion of the connection confirmation command CMD12 stored in the first reception table 52 in the second transmission table 53, in the follow-up manner (step S15).

In this state, there is no data received in the first reception table 52 of the locomotive 11-1. Therefore, as illustrated in FIG. 16, the second transmission table 53 of the locomotive 11-1 is maintained in a state in which only the locomotive ID of “10” of the locomotive 11-1 is stored.

Further, as illustrated in FIG. 15, the locomotive ID of “20” of the locomotive 11-2 and the locomotive ID of “10” of the locomotive 11-1 are stored in the second transmission table 53 of the locomotive 11-2. However, there is no data newly received in the first reception table 52 of the locomotive 11-2. Therefore, as illustrated in FIG. 16, the second transmission table 53 of the locomotive 11-2 is maintained in a state in which the locomotive ID of “20” of the locomotive 11-2 and the locomotive ID of “10” of the locomotive 11-1 are stored.

Further, as illustrated in FIG. 15, the locomotive ID of “5” of the locomotive 11-3, the locomotive ID of “20” of the locomotive 11-2, and the locomotive ID of “10” of the locomotive 11-1 are stored in the second transmission table 53 of the locomotive 11-3. However, there is no data newly received in the first reception table 52 of the locomotive 11-3. Therefore, as illustrated in FIG. 16, the second transmission table 53 of the locomotive 11-3 is maintained in a state in which the locomotive ID of “5” of the locomotive 11-3, the locomotive ID of “20” of the locomotive 11-2, and the locomotive ID of “10” of the locomotive 11-1 are stored.

Further, as illustrated in FIG. 15, the locomotive ID of “7” of the locomotive 11-4, the locomotive ID of “5” of the locomotive 11-3, the locomotive ID of “20” of the locomotive 11-2, and the locomotive ID of “10” of the locomotive 11-1 are stored in the second transmission table 53 of the locomotive 11-4. However, there is no data newly received in the first reception table 52 of the locomotive 11-4. Therefore, as illustrated in FIG. 16, the second transmission table 53 of the locomotive 11-4 is maintained in a state in which the locomotive ID of “7” of the locomotive 11-4, the locomotive ID of “5” of the locomotive 11-3, the locomotive ID of “20” of the locomotive 11-2, and the locomotive ID of “10” of the locomotive 11-1 are stored.

Further, as illustrated in FIG. 15, the locomotive ID of “3” of the locomotive 11-5, the locomotive ID of “7” of the locomotive 11-4, the locomotive ID of “5” of the locomotive 11-3, and the locomotive ID of “20” of the locomotive 11-2 are stored in the second transmission table 53 of the locomotive 11-5. Therefore, the transmission relay device control apparatus 35 stores the locomotive ID of “10” of the locomotive 11-1 stored in the first reception table 52, in the follow-up manner. As a result, as illustrated in FIG. 16, the locomotive IDs of “3”, “7”, “5”, “20”, and “10” are stored in the second transmission table 53 of the locomotive 11-5.

Next, the transmission relay device control apparatus 35 determines whether the content of the first transmission table 51 or the content of the second transmission table 53 is changed (step S16).

In the determination of step S16 in the above-mentioned example, it is determined that the content of the first transmission table 51 or the content of the second transmission table 53 is changed in all of the locomotives 11-1 to 11-5 (Yes at step S16). Therefore, the transmission relay device control apparatus 35 of each of the locomotives 11-1 to 11-5 causes the first main transmitter 31 to send the content of the first transmission table 51 as the connection confirmation command CMD11 (step S18).

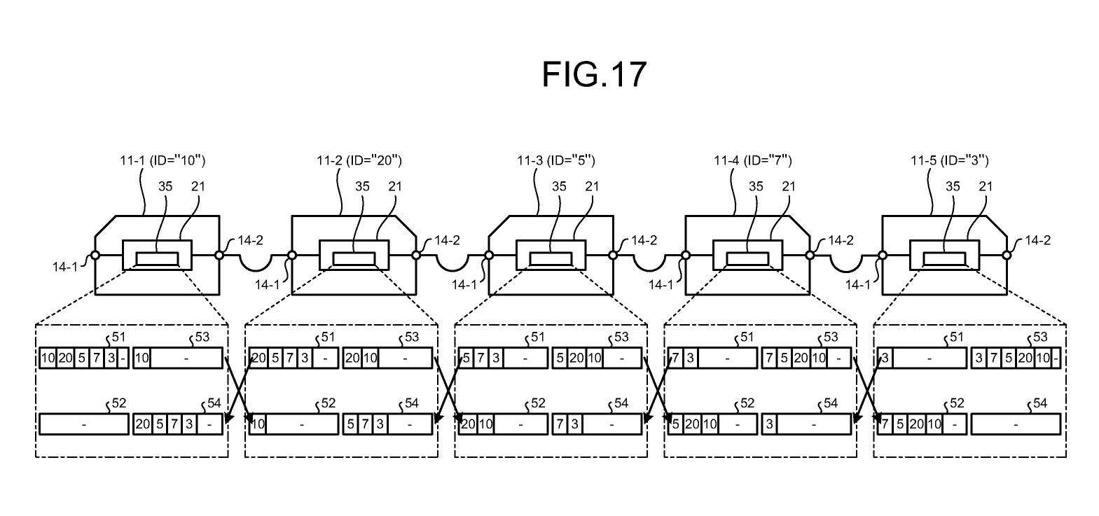

FIG. 17 is a view for explaining the states of the transmission table and the reception table after a fifth connection confirmation command is received.

Similarly, the transmission relay device control apparatus 35 of the locomotive 11-1 transmits, from the first main transmitter 31, the locomotive ID of “10” of the locomotive 11-1, the locomotive ID of “20” of the locomotive 11-2, the locomotive ID of “5” of the locomotive 11-3, the locomotive ID of “7” of the locomotive 11-4, and the locomotive ID of “3” of the locomotive 11-5, stored in the first transmission table 51.

Further, the transmission relay device control apparatus 35 of the locomotive 11-2 causes the first main transmitter 31 to transmit, towards the locomotive 11-1, the locomotive ID of “20” of the locomotive 11-2, the locomotive ID of “5” of the locomotive 11-3, the locomotive ID of “7” of the locomotive 11-4, and the locomotive ID of “3” of the locomotive 11-5, stored in the first transmission table 51 as the connection confirmation command CMD11.

Further, the transmission relay device control apparatus 35 of the locomotive 11-3 causes the first main transmitter 31 to transmit, towards the locomotive 11-2, the locomotive ID of “5” of the locomotive 11-3, the locomotive ID of “7” of the locomotive 11-4, and the locomotive ID of “3” of the locomotive 11-5 stored in the first transmission table 51 as the connection confirmation command CMD11.

Further, the transmission relay device control apparatus 35 of the locomotive 11-4 causes the first main transmitter 31 to transmit, towards the locomotive 11-3, the locomotive ID of “7” of the locomotive 11-4 and the locomotive ID of “3” of the locomotive 11-5 stored in the first transmission table 51 as the connection confirmation command CMD11.

Further, the transmission relay device control apparatus 35 of the locomotive 11-5 causes the first main transmitter 31 to transmit, towards the locomotive 11-4, the locomotive ID of “3” of the locomotive 11-5 stored in the first transmission table 51 as the connection confirmation command CMD11.

Next, the transmission relay device control apparatus 35 of each of all of the locomotives 11-1 to 11-5 causes the second main transmitter 33 to transmit the content of the second transmission table 53 as the connection confirmation command CMD12 (step S19).

That is to say, the transmission relay device control apparatus 35 of the locomotive 11-1 causes the second main transmitter 33 to transmit, toward the locomotive 11-2, the locomotive ID of “10” of the locomotive 11-1 stored in the second transmission table 53 as the connection confirmation command CMD12.

Similarly, the transmission relay device control apparatus 35 of the locomotive 11-2 causes the second main transmitter 33 to transmit, toward the locomotive 11-3, the locomotive ID of “20” of the locomotive 11-2 and the locomotive ID of “10” of the locomotive 11-1 stored in the second transmission table 53 as the connection confirmation command CMD12.

Further, the transmission relay device control apparatus 35 of the locomotive 11-3 causes the second main transmitter 33 to transmit, toward the locomotive 11-4, the locomotive ID of “5” of the locomotive 11-3, the locomotive ID of “20” of the locomotive 11-2, and the locomotive ID of “10” of the locomotive 11-1 stored in the second transmission table 53 as the connection confirmation command CMD12.

Further, the transmission relay device control apparatus 35 of the locomotive 11-4 causes the second transmitter 33 to transmit, toward the locomotive 11-4, the locomotive ID of “7” of the locomotive 11-4, the locomotive ID of “5” of the locomotive 11-3, the locomotive ID of “20” of the locomotive 11-2, and the locomotive ID of “10” of the locomotive 11-1 stored in the second transmission table 53 as the connection confirmation command CMD12.

Further, the transmission relay device control apparatus 35 of the locomotive 11-5 causes the second main transmitter 33 to transmit the locomotive ID of “3” of the locomotive 11-5, the locomotive ID of “7” of the locomotive 11-4, the locomotive ID of “5” of the locomotive 11-3, the locomotive ID of “20” of the locomotive 11-2, and the locomotive ID of “10” of the locomotive 11-1 stored in the second transmission table 53 as the connection confirmation command CMD12.

Subsequently, a processing of the transmission relay device control apparatus 35 of the locomotives 11-1 to 11-5 shifts again to S13.

Then, the transmission relay device control apparatus 35 of the locomotives 11-1 to 11-5 determines again whether the connection confirmation command CMD11 or the connection confirmation command CMD12 is received from the transmission relay device control apparatus 35 installed in other locomotive (step S13).

Then, when the connection confirmation command CMD11 is received from the first main transmitter 31 of the other transmission relay device control apparatus 35, the content of the locomotive ID portion of the connection confirmation command CMD11 is to be stored in the second reception table 54. Therefore, the content of the locomotive ID portion of the connection confirmation command CMD11 stored in the second reception table 54 is stored in the first transmission table 51, in the follow-up manner (step S14).

In this state, as illustrated in FIG. 17, the locomotive ID of “20” of the locomotive 11-2, the locomotive ID of “5” of the locomotive 11-3, the locomotive ID of “7” of the locomotive 11-4, and the locomotive ID of “3” of the locomotive 11-5 are stored in the first transmission table 51 of the locomotive 11-2, for example. However, there is no data newly received in the second reception table 54 of the locomotive 11-2. Therefore, the first transmission table 51 of the locomotive 11-2 is maintained in a state in which the locomotive ID of “20” of the locomotive 11-2, the locomotive ID of “5” of the locomotive 11-3, the locomotive ID of “7” of the locomotive 11-4, and the locomotive ID of “3” of the locomotive 11-5 are stored.

Similarly, as illustrated in FIG. 17, the locomotive ID of “10” of the locomotive 11-1, the locomotive ID of “20” of the locomotive 11-2, the locomotive ID of “5” of the locomotive 11-3, and the locomotive ID of “7” of the locomotive 11-4 are stored in the first transmission table 51 of the locomotive 11-1. Therefore, the transmission relay device control apparatus 35 stores the locomotive ID of “3” of the locomotive 11-5 stored in the second reception table 54, in the follow-up manner. As a result, as illustrated in FIG. 16, the locomotive IDs of “10”, “20”, “5”, “7”, and “3” are stored in the first transmission table 51 of the locomotive 11-1.

Further, as illustrated in FIG. 17, the locomotive ID of “5” of the locomotive 11-3, the locomotive ID of “7” of the locomotive 11-4, the locomotive ID of “3” of the locomotive 11-5 are stored in the first transmission table 51 of the locomotive 11-3. However, there is no data newly received in the second reception table 54 of the locomotive 11-3. Therefore, the first transmission table 51 of the locomotive 11-3 is maintained in a state in which the locomotive ID of “5” of the locomotive 11-3, the locomotive ID of “7” of the locomotive 11-4, and the locomotive ID of “3” of the locomotive 11-5 are stored.

Further, as illustrated in FIG. 17, the locomotive ID of “7” of the locomotive 11-4 and the locomotive ID of “3” of the locomotive 11-5 are stored in the first transmission table 51 of the locomotive 11-4. However, there is no data newly received in the second reception table 54 of the locomotive 11-4. Therefore, the first transmission table 51 of the locomotive 11-4 is maintained in a state in which the locomotive ID of “7” of the locomotive 11-4 and the locomotive ID of “3” of the locomotive 11-5 are stored.

Further, there is no data received in the second reception table 54 of the locomotive 11-5. Therefore, the first transmission table 51 of the locomotive 11-5 is maintained in a state in which only the locomotive ID of “3” of the locomotive 11-5 is stored.

Further, when the connection confirmation command CMD12 is received from the second main transmitter 33 of other transmission relay device control apparatus 35, the content of the locomotive ID portion of the connection confirmation command CMD12 is to be stored in the first reception table 52. Therefore, the transmission relay device control apparatus 35 stores the content of the locomotive ID portion of the connection confirmation command CMD12 stored in the first reception table 52 in the second transmission table 53, in the follow-up manner (step S15).

In this state, there is no data received in the first reception table 52 of the locomotive 11-1. Therefore, as illustrated in FIG. 17, the second transmission table 53 of the locomotive 11-1 is maintained in a state in which only the locomotive ID of “10” of the locomotive 11-1 is stored.

Further, as illustrated in FIG. 17, the locomotive ID of “20” of the locomotive 11-2 and the locomotive ID of “10” of the locomotive 11-1 are stored in the second transmission table 53 of the locomotive 11-2. However, there is no data newly received in the first reception table 52 of the locomotive 11-2. Therefore, as illustrated in FIG. 17, the second transmission table 53 of the locomotive 11-2 is maintained in a state in which the locomotive ID of “20” of the locomotive 11-2 and the locomotive ID of “10” of the locomotive 11-1 are stored.

Further, as illustrated in FIG. 17, the locomotive ID of “5” of the locomotive 11-3, the locomotive ID of “20” of the locomotive 11-2, and the locomotive ID of “10” of the locomotive 11-1 are stored in the second transmission table 53 of the locomotive 11-3. However, there is no data newly received in the first reception table 52 of the locomotive 11-3. Therefore, as illustrated in FIG. 17, the second transmission table 53 of the locomotive 11-3 is maintained in a state in which the locomotive ID of “5” of the locomotive 11-3, the locomotive ID of “20” of the locomotive 11-2, and the locomotive ID of “10” of the locomotive 11-1 are stored.

Further, as illustrated in FIG. 17, the locomotive ID of “7” of the locomotive 11-4, the locomotive ID of “5” of the locomotive 11-3, the locomotive ID of “20” of the locomotive 11-2, and the locomotive ID of “10” of the locomotive 11-1 are stored in the second transmission table 53 of the locomotive 11-4. However, there is no data newly received in the first reception table 52 of the locomotive 11-4. Therefore, as illustrated in FIG. 17, the second transmission table 53 of the locomotive 11-4 is maintained in a state in which the locomotive ID of “7” of the locomotive 11-4, the locomotive ID of “5” of the locomotive 11-3, the locomotive ID of “20” of the locomotive 11-2, and the locomotive ID of “10” of the locomotive 11-1 are stored.

Further, as illustrated in FIG. 17, the locomotive ID of “3” of the locomotive 11-5, the locomotive ID of “7” of the locomotive 11-4, the locomotive ID of “5” of the locomotive 11-3, the locomotive ID of “20” of the locomotive 11-2, and the locomotive ID of “10” of the locomotive 11-1 are stored in the second transmission table 53 of the locomotive 11-5. However, there is no data newly received in the first reception table 52 of the locomotive 11-5. Therefore, as illustrated in FIG. 17, the second transmission table 53 of the locomotive 11-5 is maintained in a state in which the locomotive IDs of “3”, “7”, “5”, “20”, and “10” are stored.

Next, the transmission relay device control apparatus 35 determines whether the content of the first transmission table 51 or the content of the second transmission table 53 is changed (step S16).

As a result of the determination of step S16 in this case, it is determined that the content of the first transmission table 51 or the content of the second transmission table 53 of all of the locomotives 11-1 to 11-5 do not change (No at step S16). Therefore, the transmission relay device control apparatus 35 determines whether a predetermined time has elapsed since the content of the first transmission table 51 or the content of the second transmission table 53 is last changed (step S17).

At step S17, when it is determined that the predetermined time has elapsed since the content of the first transmission table 51 or the content of the second transmission table 53 is last changed (No at step S17), the transmission relay device control apparatus 35 performs again the process of S13, and repeats the similar process.

In the present example, it is to be determined that the predetermined time has elapsed since the content of the first transmission table 51 or the content of the second transmission table 53 is last changed (Yes at step S17). Therefore, the connection confirmation process is to be completed.

As a result, at the time when the connection confirmation process is completed, it becomes possible to recognize the vehicle formation based on the number of the connected locomotives and the locomotive IDs of each of the locomotives.

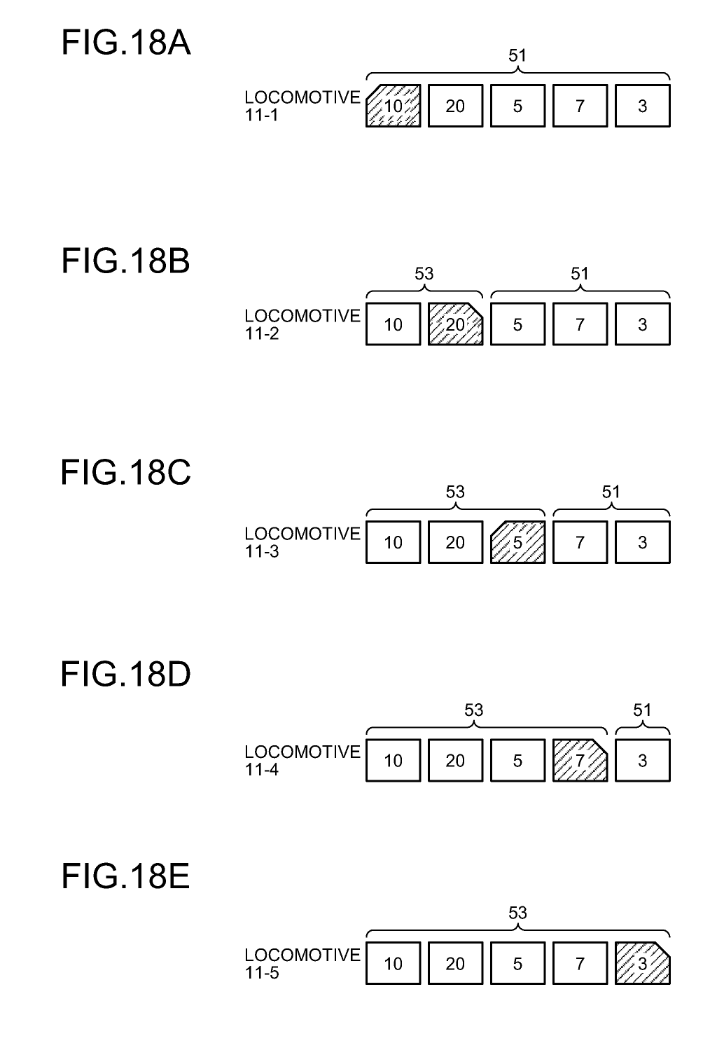

FIGS. 18A-18E are views for explaining confirmation state of the number of connected locomotives and vehicle formation state after performing the connection confirmation process.

As illustrated in FIGS. 18A-18E, when the connection confirmation process is completed, the transmission relay device control apparatus 35 of each of the locomotives 11-1 to 11-5 can recognize a direction of the each of the locomotives 11-1 to 11-5 and a locomotive IDs of the connected locomotives based on the preliminarily recognized direction of the each of the locomotives 11-1 to 11-5 and the content of the first transmission table 51 and the second transmission table 53.

For example, in FIGS. 18A-18E, the front of the transmission relay device control apparatus 35 of the locomotive 11-3 is in the leftward direction. Therefore, by combining this with the content of the first transmission table 51 and the second transmission table 53, it can be recognized that: two locomotives of the locomotive IDs of “10” and “20” are connected at the front of the locomotive 11-3; and two locomotives of the locomotive IDs of “7” and “3” are connected at the back of the locomotive 11-3.

In the above-mentioned explanation, the number of connected locomotives and the vehicle connection formation can be recognized. However, directions of the locomotives relative to each other cannot be recognized.

Therefore, it is next explained a process for confirming the direction of the locomotive.

The locomotive IDs of all of the connected locomotives are known from the aforementioned connection confirmation process. Accordingly, one of the locomotives complying with a predetermined rule transmits a direction confirmation command. As a result, other locomotives determine whether they are in the same direction or opposite direction with reference to the direction of a reference locomotive. Here, the reference locomotive is the locomotive that has transmitted the direction confirmation command.

In the following, explanations are provided in details.

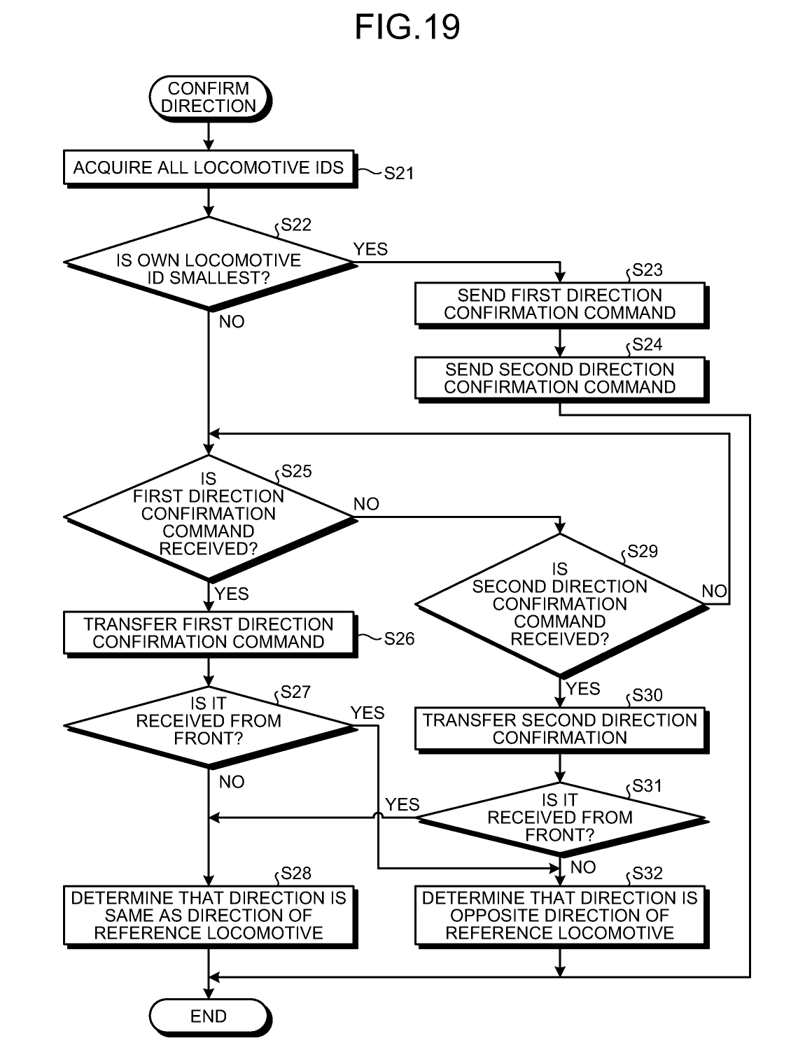

FIG. 19 is a flowchart of the direction confirmation process.

In the following explanation, as a predetermined rule, a locomotive with the smallest locomotive ID is selected as the reference locomotive that transmits the direction confirmation command.

First, the transmission relay device control apparatus 35 of each of the locomotives 11-1 to 11-5 acquires the locomotive IDs of all of the locomotives via the connection confirmation process (step S21).

Next, the transmission relay device control apparatus 35 determines whether the locomotive ID of the locomotive in which own transmission relay device control apparatus 35 is installed is the smallest (step S22).

In particular, the transmission relay device control apparatus 35 of the each of the locomotives 11-1 to 11-5 compares the locomotive ID of its own stored in the memory 36 and a plurality of locomotive IDs stored in the first transmission table 51 and the second transmission table 53 with each other, and determines whether own locomotive ID is the smallest.

At step S22, if it is determined that the locomotive ID of the locomotive in which its own device is installed is the smallest among the locomotive IDs of all of the locomotives (Yes at step S22), the transmission relay device control apparatus 35 transmits the first direction confirmation command (reference locomotive forward confirmation command) from the front of the locomotive, since the locomotive is the reference locomotive.

In particular, according to the state as illustrated in FIG. 17, the locomotive ID of the locomotive 11-5 is “3”, which is the smallest value among all of the locomotive IDs. Therefore, the transmission relay device control apparatus 35 of the locomotive 11-5 transmits a first direction confirmation command (reference locomotive forward confirmation command) CMD21 from the second main transmitter 33, which is provided at the front of the locomotive 11-5.

Subsequently, the transmission relay device control apparatus 35 transmits a second direction confirmation command CMD22 from the back of the locomotive 11-5 (step S23).

As a result, the transmission relay device control apparatus 35 of other locomotive can recognize that: a side at which the first direction confirmation command CMD21 is received opposes the front of the reference locomotive; and a side at which the second direction confirmation command CMD22 is received opposes the back of the reference locomotive.

On the other hand, as a result of the determination of step S22, if the locomotive ID of the locomotive to which own transmission relay device control apparatus 35 does not have the smallest value among the values of the locomotive IDs of the locomotives (No at step S22), the transmission relay device control apparatus 35 waits for an input of at least one of the first direction confirmation command and the second direction confirmation command from other transmission relay device control apparatus 35 installed in other locomotive that is the reference locomotive. Here, the transmission relay device control apparatus 35 waits for the input because the locomotive in which the transmission relay device control apparatus 35 is installed is not the reference locomotive.

In particular, the transmission relay device control apparatus 35 installed in any of the locomotives other than the reference locomotive determines whether the first direction confirmation command is received (step S25).

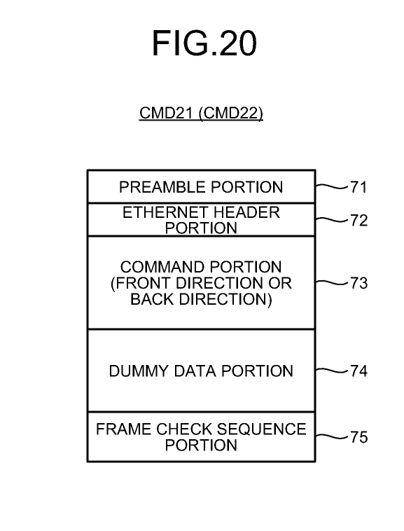

FIG. 20 is a view for explaining data format of the first direction confirmation command and the second direction confirmation command. FIG. 20 is a data format of the direction confirmation command of when Ethernet (registered trademark) is used as the communication standard.

The first direction confirmation command CMD21 and the second direction confirmation command CMD22 have the same data format. The first direction confirmation command CMD21 and the second direction confirmation command CMD22 comprises, from the beginning: a preamble portion 71 for establishing communication synchronization; an Ethernet header portion 72 that stores therein a destination address, a source address, and the like; a command portion 73 that indicates that the command is the first direction confirmation command CMD21 or the second direction confirmation command CMD22; a dummy data portion 74 in which all data=“0”; and a frame check sequence (FCS) portion that stores the CRC for error check.

In the determination of step S25, when the first direction confirmation command CMD21 is received (Yes at step S25), the transmission relay device control apparatus 35 transfers the first direction confirmation command CMD21 (step S26). Further, the transmission relay device control apparatus 35 determines whether the first direction confirmation command is received from the front of the locomotive (step S27). Here, if the first direction confirmation command is received from the front of the locomotive, the first direction confirmation command is transferred to the locomotive that is connected to the back. On the other hand, if the first direction confirmation command is received from the back of the locomotive, the first direction confirmation command is transferred to the locomotive that is connected to the front.

In the determination of step S27, if the first direction confirmation command CMD21 is received from the front of the locomotive (Yes at step S27), the locomotive that received the first direction confirmation command from the front thereof is in a direction such that the front of the locomotive and the front of the reference locomotive oppose each other. Therefore, the transmission relay device control apparatus 35 determines that the locomotive is in a direction opposite the reference locomotive (step S32).

In the determination of step S27, if the first direction confirmation command CMD21 is received from the back of the locomotive (Yes at step S27), the front of the locomotive that received the first direction confirmation command CMD21 from the front thereof and the front of the reference locomotive are in the same direction. Therefore, the transmission relay device control apparatus 35 determines that the direction of the locomotive and the direction of the reference locomotive are in the same direction (step S28).

In the determination of S25, when the first direction confirmation command CMD21 is not received (No at step S25), the transmission relay device control apparatus 35 installed in a locomotive other than the reference locomotive determines whether the second direction confirmation command CMD22 is received (step S29).

In the determination of step S29, if the second direction confirmation command CMD22 is received (Yes at step S29), the transmission relay device control apparatus 35 transfers the second direction confirmation command CMD22 (step S30). Further, the transmission relay device control apparatus 35 determines whether the second direction confirmation command CMD22 is received from the front of the locomotive (step S31).

Here, if the second direction confirmation command CMD22 is received from the front of the locomotive, the second direction confirmation command CMD22 is transferred to the locomotive connected at the back. On the other hand, if the second direction confirmation command CMD22 is received from the back of the locomotive, the second direction confirmation command CMD22 is transferred to the locomotive connected to the front. In particular, the locomotive 11-4 transfers the second direction confirmation command CMD22 to the locomotive 11-3 connected to the back of the locomotive 11-4 because the locomotive 11-4 receives the second direction confirmation command CMD22 from the locomotive 11-5 connected to the front of the locomotive 11-4. Similarly, the locomotive 11-3 transfers the second direction confirmation command CMD22 to the locomotive 11-2 connected to the front of the locomotive 11-3 since the locomotive 11-3 receives the second direction confirmation command CMD22 from the locomotive 11-4 connected to the back of the locomotive 11-3.

In the determination of step S31, when the second direction confirmation command is received from the front of the locomotive (Yes at step S31), the front direction of the locomotive that has received the second direction confirmation command and the front direction of the reference locomotive are in the same direction. Therefore, the transmission relay device control apparatus 35 determines that it is facing in the same direction as the reference locomotive (step S28).

In the determination of step S31, if the second direction confirmation command is received from the back of the locomotive (No at step S31), the front direction of the locomotive that has received the second direction confirmation command from the back and the front direction of the reference locomotive oppose each other. Therefore, the transmission relay device control apparatus 35 determines that it is in a direction opposite the reference locomotive (step S32).

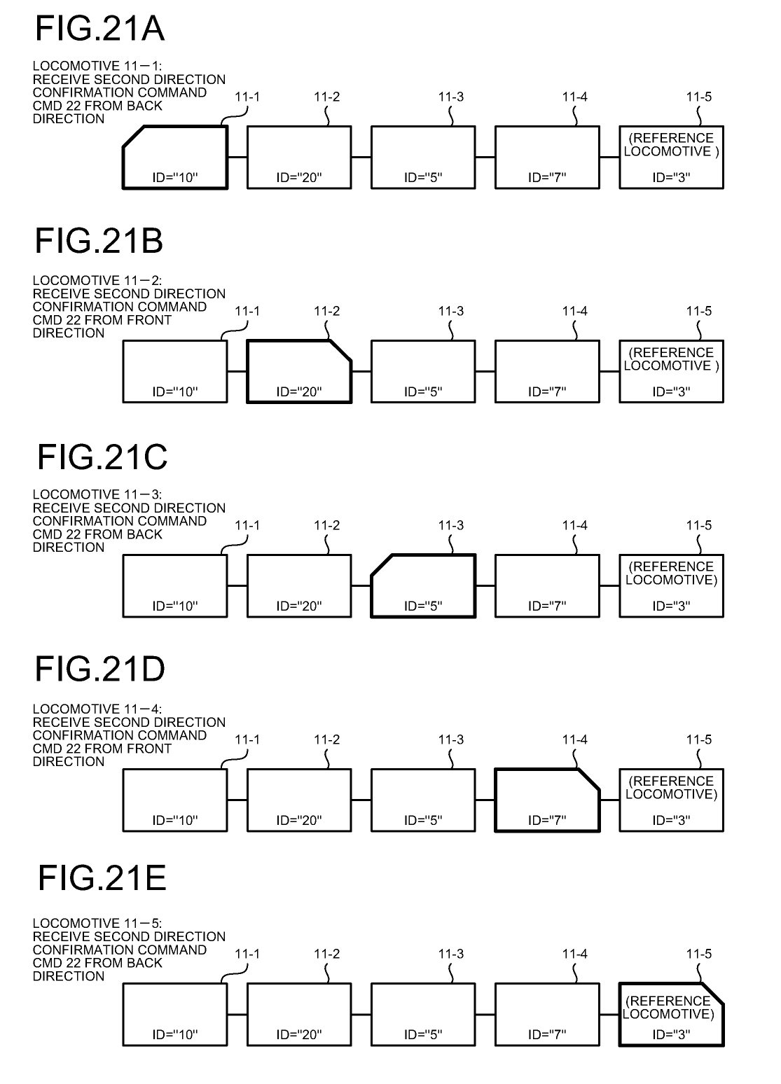

FIGS. 21A-21E are views for explaining the direction confirmation process.

As a result of the above, the transmission relay device control apparatus 35 of the locomotive 11-1 receives the second direction confirmation command CMD22 from the back direction. Therefore, the transmission relay device control apparatus 35 of the locomotive 11-1 determines that the locomotive 11-1 is facing in the direction opposite the reference locomotive.

Further, the transmission relay device control apparatus 35 of the locomotive 11-2 receives the second direction confirmation command CMD22 from the front direction. Therefore, the transmission relay device control apparatus 35 of the locomotive 11-2 determines that it is facing in the same direction as the reference locomotive.

Further, the transmission relay device control apparatus 35 of the locomotive 11-3 receives the second direction confirmation command CMD22 from the back direction. Therefore, the transmission relay device control apparatus 35 of the locomotive 11-3 determines that it is facing in the direction opposite the reference locomotive.

Further, the transmission relay device control apparatus 35 of the locomotive 11-4 receives the second direction confirmation command CMD22 from the front direction. Therefore, the transmission relay device control apparatus 35 of the locomotive 11-4 determines that it is facing in the same direction as the reference locomotive.

Further, the transmission relay device control apparatus 35 of the locomotive 11-5 transmits the first direction confirmation command CMD21 from the front direction, as the reference locomotive. Further, the transmission relay device control apparatus 35 of the locomotive 11-5 transmits the second direction confirmation command CMD22 from the back direction. Accordingly, the transmission relay device control apparatus 35 of the locomotive 11-5 recognizes that its direction is a reference.

Then, as a result of the connection confirmation process and the direction confirmation process, the transmission relay device control apparatus 35 of each of the locomotives 11-1 to 11-5 are connected to each other in the direction indicated in FIG. 4. Furthermore, the locomotive IDs of the locomotives 11-1 to 11-5 can be confirmed.

As a result, the vehicle formation (number of locomotives, order of locomotives, directions of vehicle) can automatically acquired even in a locomotive system which ordinarily performs connection and disconnection. Therefore, a locomotive system with high operability and maintainability can easily be constructed.

Although not described in details in the above-mentioned explanation, there is possibility that the connection confirmation command CMD11 and the connection confirmation command CMD12 collide against each other. Therefore, the connection confirmation command CMD11 and the connection confirmation command CMD12 are transmitted at a constant period or at a random period.

Further, in the above explanation, the transmission path is shared for transmission and reception. However, if the transmission and the reception are separated from each other, a fixed value may be used since no collusion occurs.

Further, in the above-mentioned explanation, the Ethernet is used as the communication standard. However, it may be configured to use other communication standard.

Further, in the above explanation, there is provided a configuration in which one transmission core unit 21 is provided to each of the transmission relay device control apparatus 35. However, there may be provided a plurality of transmission device main bodies 21 to provide a plurality of transmission paths. Consequently, even if one of the transmission core units 21 or one of the transmission paths connected to the transmission core units 21 is put in the transmission impossible state, the transmission can be continued via the transmission core unit 21 and the corresponding transmission passage.

The transmission apparatus for a railway vehicle of the present embodiment has a hardware configuration utilizing a normal computer comprising: a control apparatus such as a CPU; a memory apparatus such as a read only memory (ROM) and a RAM; and the like.

The control program executed in the transmission apparatus for the railway vehicle of the present embodiment may be configured to be stored in a computer readable storage medium as an installable or executable file, and provided. The computer readable storage medium is, for example, a CD-ROM, a flexible disk (FD), a CD-R, a digital versatile disk (DVD), and/or the like.

Further, the control program executed by the transmission apparatus for the railway vehicle of the present embodiment may be configured as follows. That is, the control program is stored in a computer connected to a network such as the Internet, and provided by download via the network. Further, the control program executed in the transmission apparatus for the railway vehicle of the present embodiment may be configured so as to be provided or distributed via a network such as the Internet.

Further, the control program of the transmission apparatus for the railway vehicle of the present embodiment may be configured so as to be preliminarily embedded in the ROM or the like and provided.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1-9. (canceled)

10. A transmission apparatus installed in a locomotive having ID information, with a first connecting direction and a second connecting direction opposite the first connecting direction being defined for the locomotive, the transmission apparatus comprising:
a transmission unit that transmits the ID information received from other locomotive from one of the first connecting direction and the second connecting direction to other one of the first connecting direction and the second connecting direction; and
a connection state determination unit that determines a connection state between the other locomotive and the locomotive in which the transmission apparatus is installed, based on the received ID information.

11. The transmission apparatus according to claim 10, wherein the transmission unit includes:
a first transmission unit that adds own ID information to an ID information sequence including a piece of ID information or a plurality of pieces of ID information received from the first connecting direction; and
a second transmission unit that adds own ID information to an ID information sequence including a piece of ID information or a plurality of pieces of ID information received from the second connecting direction.

12. The transmission apparatus according to claim 11, comprising a transmission control unit that determines that the reception of the ID information is completed when the ID information sequence in the first transmission unit and the ID information sequence in the second transmission unit do not change for greater than or equal to a predetermined time period, each of the ID information sequences including the received piece of ID information or the received pieces of ID information.

13. The transmission apparatus according to claim 12, wherein, when own ID information is a specific locomotive, after the reception of the ID information is completed, the transmission controller unit causes the first transmission unit to transmit a first direction confirmation instruction and causes the second transmission unit to transmit a second direction confirmation instruction, the specific locomotive being a unique locomotive having own ID information satisfying a predetermined condition.

14. The transmission apparatus according to claim 13, comprising a vehicle direction determining unit that determines, based on whether the first communication unit or the second communication unit has received the first direction confirmation instruction or the second direction confirmation instruction, whether a direction is in same direction or opposite direction with respect to a direction of the specific locomotive.

15. The transmission apparatus according to claim 13, wherein a communication control unit continues transmitting an information request signal that request for transmission of ID information via a communication unit to which other locomotive is not connected from among the first transmission unit and the second transmission unit, the communication control unit recognizing that it is installed in locomotives connected, respectively, to both ends among a plurality of connected locomotives based on the ID information.

16. A locomotive, to be connected to other locomotive, having ID information, a first connecting direction and a second connecting direction opposite the first connecting direction being defined for the locomotive, the locomotive comprising:
a first connector that is provided at the first connecting direction of a vehicle;
a second connector that is provided at the second connecting direction of the vehicle;
a transmission unit that transmits the ID information received from the other locomotive from one of the first connector and the second connector to other one of the first connector and the second connector; and
a connection state determination unit that determines a connection state between the other locomotive and a locomotive in which the connection state determination unit is installed, based on the received ID information.

17. A control method performed in a transmission apparatus installed in a locomotive having ID information, a first connecting direction and a second connecting direction opposite the first connecting direction being defined for the locomotive, the method comprising:
transmitting the ID information received from other locomotive from one of the first connecting direction and the second connecting direction to other one of the first connecting direction and the second connecting direction; and
determining a connection state between the other locomotive and a locomotive in which the transmission apparatus is installed, based on the received ID information.
